(19) United States
(12) Patent Application Publication
(10) Pub. No.: US 2024/0233128 A1
(43) Pub. Date: Jul. 11, 2024

(54) SYSTEMS AND METHODS FOR ITERATIVE AND ADAPTIVE OBJECT DETECTION

(71) Applicant: NVIDIA Corporation, Santa Clara, CA (US)

(72) Inventor: Shekhar Dwivedi, Santa Clara, CA (US)

(21) Appl. No.: 18/094,159

(22) Filed: Jan. 6, 2023

(51) Int. Cl. G06T 7/11; G06T 7/187; G06V 10/36; G06V 10/94

(52) U.S. Cl. CPC G06T 7/11; G06T 7/187; G06V 10/36; G06V 10/955; G06T 2207/10081; G06V 2201/03

(57) ABSTRACT

Apparatuses, systems, and techniques for improved object detection and/or segmentation are disclosed. In at least one embodiment, an object is detected in input data via iterative transformation and processing of the input data and aggregation of a result of each iteration into a combined object detection result.

### TECHNICAL FIELD

Embodiments of the disclosure generally relate to image processing, and more specifically, to improved object detection techniques.

### BACKGROUND

Many image processing, computer vision, and computer graphics applications involve performing object detection to locate (or localize) semantic objects within an image, video sequence, or the like. In some cases, objects may be localized at a granular level, e.g., by identifying each pixel or voxel of the object in the image.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system according to at least one embodiment;

FIG. 2 illustrates a flow diagram of an example method for performing object detection and segmentation, according to at least one embodiment;

FIG. 3 illustrates a flow diagram of an example method for performing object detection, according to at least one embodiment;

FIG. 4 illustrates an example sequence for performing object detection and segmentation, according to at least one embodiment;

FIG. 5 illustrates an example process for performing object detection and segmentation for an example application of CT imaging, according to at least one embodiment;

FIG. 6 illustrates example results of an object detection and segmentation process for an example application of CT imaging, according to at least one embodiment;

FIG. 7 illustrates a computer system, according to at least one embodiment;

FIG. 8 illustrates a parallel processing unit (“PPU”), according to at least one embodiment;

FIG. 9 illustrates a general processing cluster (“GPC”), according to at least one embodiment;

FIG. 10 illustrates a memory partition unit of a parallel processing unit (“PPU”), according to at least one embodiment;

FIG. 11 illustrates a streaming multi-processor, according to at least one embodiment;

FIG. 12 illustrates a computer system, according to at least one embodiment;

FIG. 13A illustrates a parallel processor, according to at least one embodiment;

FIG. 13B illustrates a partition unit, according to at least one embodiment;

FIG. 13C illustrates a processing cluster, according to at least one embodiment;

FIG. 13D illustrates a graphics multiprocessor, according to at least one embodiment.

### DETAILED DESCRIPTION

Object detection is an important technique used in a variety of image processing, computer vision, and computer graphics applications in which one or more semantic objects are located (or localized) within an image, video sequence, or the like. Object segmentation is an extension of object detection in which semantic objects are localized at a granular level, e.g., by identifying each pixel or voxel of a particular semantic object. As an illustrative example, in the medical field, diagnostic imaging may be used to help diagnose and treat a medical condition. Different imaging modalities (e.g., ultrasound, computed tomography (CT), magnetic resonance imaging (MRI), positron emission tomography, fluoroscopy, optical tomography, etc.), for example, may be used to capture images (or videos, or other multi-dimensional data) of anatomical structure or physiological functions. The captured images may be processed in order to assist clinicians in making a diagnosis or providing treatment, for example, to automatically detect relevant structures and/or activities within the body. A high-resolution CT scan, for instance, may be performed to capture the bone structure of a patient (e.g., to identify a fracture or other bone damage); the resulting CT image can be processed to automatically identify the bone structure (e.g., to locate and discriminate between pixels or voxels containing bone and those that do not).

Object detection and segmentation are algorithmically challenging and computationally intensive tasks. Current approaches for performing object detection and segmentation typically rely either on artificial intelligence (e.g., a deep learning model) or more classical computer vision techniques (e.g., thresholding, region-growing, clustering, etc.), both of which are often time consuming and/or are less accurate than desired for detecting or segmenting an object. Improved object detection and segmentation techniques are disclosed herein in which an image or other multi-dimensional input data may be iteratively processed to accurately identify one or more objects captured therein. In some embodiments, for example, an iterative object detection process may be performed in which, for each iteration, a data transformation may be applied to the image or other multi-dimensional input data and a portion of the one or more objects may be detected in the transformed image or data. The output of each iteration may be merged to obtain a combined object detection. The iterative object detection process may repeat until a fixed number of iterations have been completed and/or until a termination criterion has been (or termination criteria have been) satisfied. In some embodiments, the parameters of the data transformation and/or object detection operations may be adapted between each iteration in order to facilitate detection of unique portions of the one or more objects in each iteration. Upon completion of the iterative object detection process, the combined object detection may be segmented (e.g., where object elements are grouped and labeled) into one or more objects, some (or all) of which may be selected to produce a final object identification

By structuring the process as the iterative application of a data transformation and object detection, the iterative object detection process may be better suited for hardware accelerated execution (e.g., using one or more parallel processors). In some embodiments, the data transformation operation may be performed on the same input data for each iteration (e.g., without reduction in resolution), which may further facilitate parallel execution of the object detection technique. Furthermore, in some embodiments, the parameter changes between each iteration of the object detection may be determined in advance, which may allow for even further acceleration, as multiple iterations of both the data transformation and objection detection may be performed in parallel. Moreover, by processing the input data using different parameters in at least two iterations, the ability to detect unique portions of an object may be enhanced, ultimately providing a more accurate object detection and segmentation result.

The systems and methods described herein may be used, for example and without limitation, in systems associated with non-autonomous vehicles, semi-autonomous vehicles (e.g., in one or more adaptive driver assistance systems (ADAS)), autonomous vehicles, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

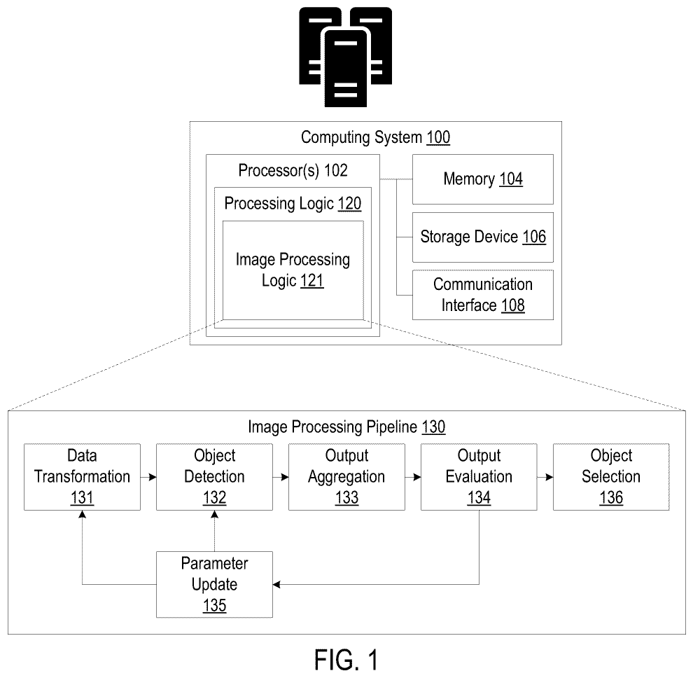

FIG. 1 illustrates an example computing system 100 that may employ the improved object detection and segmentation techniques of the present disclosure. Computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), and/or other computing device. It will be appreciated that, in some embodiments, computing system 100 may be a virtualized instance of a computer server, with the underlying hardware resources being provided by pools of shared computing resources (e.g., shared processor pools, shared memory pools, etc.) that may be dynamically allocated and accessed as needed.

Computing system 100 may include one or more processors 102 that may be coupled to and communicate with memory 104, storage device 106, and communication interface 108 Memory 104 may include one or more memory modules, including for example, a dual in-line memory module (DIMM), a small outline DIMM (SO-DIMM), various types of non-volatile dual in-line memory modules (NVDIMMs), or the like. In some embodiments, memory 104 may include one or more input and output buffers where data used in performing an object detection and segmentation process may be written to, read from, or operated on.

Storage device 106 may include one or more of a solid-state drive (SSD), a flash drive, a universal serial bus (USB) flash drive, an embedded Multi-Media Controller (eMMC) drive, a Universal Flash Storage (UFS) drive, a secure digital (SD) card, a hard disk drive (HDD), or the like. In some embodiments, storage device 106 may include one or more data stores (e.g., database, file repositories, etc.). In some embodiments, for example, storage device 106 may include data stores in which source images that are to undergo object detection and segmentation may be stored.

Communication interface 108 may include one or more network interfaces, including for example, an Ethernet interface, a WiFi interface, a Bluetooth interface, a near field communication (NFC) interface, and/or the like.

In some embodiments, computing system 100 may be a heterogenous computing system that includes multiple types of processor(s) 102, including for example, one or more central processing units (CPUs), graphics processing units (GPUs), data processing units (DPUs), digital signal processors (DSPs), field-programmable gate arrays (FPGAs), or application specific integrated circuits (ASICs). In some embodiments, processor(s) 102 may include one or more cores, one or more caches, a memory controller (e.g., NVDIMM controller), and/or a storage protocol controller (e.g., PCIe controller, SATA controller).

In some embodiments, processor(s) 102 may be coupled to and communicate with memory 104, storage device 106, and/or communication interface 108 via a physical host interface, including for example, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc.

Processor(s) 102 may include processing logic 120, which may include one or more processing logic sub-components, that can be used to perform different processes and/or operations. In some embodiments, processing logic 120 may implement one or more image processing pipelines to perform different image processing processes. An image processing pipelines may include a number of processing stages that may be connected together to perform an image processing process. Each processing stage may accept a number of inputs, perform a number of sub-processes or operations using the inputs, and generate a number of outputs. The outputs of one stage may be provided to one or more other stages to form the image processing pipeline. In some embodiments, for example, each processing stage may maintain one or more buffers to store inputs that are received and outputs that may be generated for a processing stage and use one or more queues to send outputs to a subsequent processing stage (or subsequent processing stages) in the processing pipeline. In some cases, an output buffer of one processing stage may be treated as an input buffer of another processing stage, which may allow for in place processing between stages and reduce an overall memory burden.

In some embodiments, for example, processing logic 120 may include image processing logic 121 that may be used to perform different image processing techniques, including for example, object detection and/or segmentation techniques. In some embodiments, image processing logic 121 may implement image processing pipeline 130 to perform object detection and segmentation on an image. By way of example, image processing pipeline 130 may perform an object detection and segmentation process on a high-resolution CT image to identify anatomical structure(s) captured therein (e.g., hard or soft tissue structure(s)). In some embodiments, image processing pipeline 130 may include a data transformation stage 131, an object detection stage 132, an output aggregation stage 133, an output evaluation stage 134, a parameter update stage 135, and an object selection stage 136. Additional detail regarding the processing stages of image processing pipeline 130 is provided by way of example in the discussion herein.

Image processing pipeline 130 may correspond to a complete image processing pipeline, or may not represent a complete processing pipeline, as one or more additional and/or alternative stages may be included in (and/or operations may be performed in a stage of) image processing pipeline 130 or in addition to image processing pipeline 130. Such additional stages and/or operations may include, for example, an image capture stage in which the image is captured using an image capture device, or a display stage in which the results of the object detection and segmentation process are presented to a user (e.g., on a display device). As another example, in some embodiments, image processing pipeline 130 may involve a region definition stage, in which an input image may be divided into one or more regions of interest (or sub-images). Each region of interest may undergo a separate object detection and segmentation process, the results of which may be combined (e.g., at output aggregation stage 133). Such stages and/or operations are not critical to the understanding of the present disclosure and a detailed discussion of such stages has been omitted for the sake of clarity and brevity. However, it should be understood that the image processing pipeline 130 may include additional and/or alternative stages and/or operations, which may be performed before, between, as part of, and/or after those enumerated herein.

In some embodiments, the object detection and segmentation technique performed by image processing pipeline 130 may involve iteratively processing an image to identify elements (e.g., pixels, voxels, etc.) that correspond to one or more objects captured in the image. In some embodiments, for example, an iterative object detection process (e.g., involving stages 131-135) may be performed on an image to detect a portion of one or more objects in each iteration (e.g., in stages 131-132), with the results of each iteration being merged to obtain a combined object detection (e.g., in stage 133). For instance, in some embodiments, each iteration may involve applying a data transformation to the image (e.g., in stage 131) and processing the transformed image to detect a portion of the one or more objects (e.g., in stage 132). The iterative object detection process may repeat until a fixed number of iterations have been completed and/or until a termination criterion has been (or termination criteria have been) satisfied (e.g., as determined in stage 134). In some embodiments, the iterative object detection process may be adaptive in nature, for example, with the parameters of the data transformation and object detection operations being updated between each iteration (e.g., in stage 135), which may help to facilitate detection of unique parts of an object in each iteration. Upon completion of the iterative object detection process, the combined object detection may be segmented (e.g., where object elements are grouped and labeled) into one or more objects, some (or all) of which may be selected to produce a final object identification (e.g., in stage 136).

As previously discussed, in some embodiments, image processing pipeline 130 may also include a region definition stage in which an image may be divided into one or more sub-images (e.g., corresponding to one or more regions of interest in the image). In such cases, each sub-image may undergo a separate iterative object detection process (e.g., involving separate instances of stages 131-132), with the results being merged to obtain a combined object detection for each sub-image and/or for the image as a whole (e.g., at stage 133). By way of example, a high-resolution CT scan may be a whole-body scan, and the CT image generated by the scan may capture a skeletal structure of a patient as well as a structure of different organs of the patient. At the region definition stage, the CT image generated by the scan may be divided into one or more sub-images, for example, covering the entire skeletal structure (e.g., the entire CT image) or different portions thereof (e.g., a skull region covering the head and upper vertebrae, an abdominal region etc.), or different organs (e.g., a liver region, a kidney region, a heart region, etc.). A separate object detection and segmentation process may then be performed on each sub-image. For instance, with respect to the previously described CT image, separate object detection and segmentation processes may be performed on each sub-image thereof based on the object sought to be detected in each region of interest (e.g., performing a different object detection process to detect a dense bone structure, for example, in a chest region, from one to detect a sparse bone structure, for example, in an abdominal region). For example, based on the object being detected in each region (e.g., whole body bone structure, organ structure, etc.) different data transformations and object detection processes may be applied, different termination criteria may be employed, and/or different parameter updates may be made. In some embodiments, the object detection and segmentation processes that are performed on the image (or sub-image thereof) may be based on different anatomical heuristics (e.g., which may depend on the object being detected, the corresponding anatomical region of the sub-image, etc.).

At data transformation stage 131, a data transformation may be applied to an input image to generate a transformed image as an output. In some embodiments, for example, a data transformation may be applied to an input image for each of one or more processing iterations (e.g., generating a transformed image in each processing iteration) of an iterative object detection process. The transformed image(s) that are generated at data transformations stage 131 may be provided to subsequent stages of image processing pipeline 130 (e.g., as an input to object detection stage 132).

In some embodiments, an image (e.g., that captures one or more objects for detection) may be retrieved from a storage device (e.g., from an image database or repository on storage device 106) and placed in an input buffer (e.g., in memory 104) for processing. In some embodiments, the image may be a sub-image received from a region definition stage and placed in an input buffer (e.g., in memory 104) for processing. In some embodiments, the image may be made up of one or elements (e.g., picture elements (or pixels), volume elements (or voxels), etc.) in a defined arrangement (e.g., a spatial arrangement). An image, for example, may have a particular size, which may be expressed in terms of a resolution, indicating a number of picture elements in each of one or more dimensions. An image, for instance, may take the form of a two-dimensional (2D) image (e.g., having a resolution of 720×480 pixels, 1920×1800 pixels, 3840×2160 pixels, etc.), a three-dimensional (3D) image (e.g., having a resolution of 1024×1024×1024 voxels, 2048×2048×2048 voxels, etc.), a video sequence (e.g., comprising a sequence of 2D or 3D image frames), or some other multi-dimensional image. Each element of an image (or image element) may convey certain information, which may be defined by a format of the image. The format of an image, for example, may indicate the number and type of values conveyed for each element (e.g., grayscale, RGB, or YUV intensity values) and corresponding value size (e.g., 8-bit, 10-bit, 16-bit, etc.) indicating the range of values that can be taken (e.g., 0-255, 0-1023, 0-65,536, etc.). As an example, a 3D image (e.g., generated by a high-resolution CT scan) may have a size of 2048×2048×2048 voxels, with each voxel element having a 10-bit grayscale intensity value (e.g., between 0-1023).

A data transformation may be applied to the input image (which may also be referred to as a “source image”) to generate a transformed image. In some embodiments, for example, a data transformation may operate to modify the elements of the input image (e.g., modify pixel or voxel intensity values) to generate the transformed image. In some embodiments, a data transformation may generate a transformed image having a same size (e.g., a same resolution) as the input image, while in others, it may generate a transformed image having a different size. In some embodiments, the transformed image may be in the same format as the input image, while in others, it may generate a transformed image in a different format (e.g., when converting images between color spaces). In some embodiments, the transformed image that is generated may be written to an output buffer (e.g., in memory 104). In some embodiments, the transformed image may be provided to subsequent stages of image processing pipeline 130 (e.g., as an input to object detection stage 132). In some embodiments, for instance, a transformed image may be added to a processing queue of another processing stage (e.g., a processing queue of object detection stage 132).

In some embodiments, the data transformation applied to an input image may be completed through the performance of one or more data processing operations, which may be performed in accordance with one or more operation settings or parameters. In some embodiments, the data transformation applied to an input image may enhance or otherwise transform the image, for example, to produce better results at a subsequent processing stage. In some embodiments, for instance, a data transformation may be applied to an image that may facilitate detection of objects captured therein (e.g., relative to processing of the input image itself). By way of example, a data transformation may be applied to a CT image (or sub-image thereof) that may enhance the image to better facilitate detection of hard tissue (e.g., bone structure) and/or soft tissue (e.g., organ structures) captured therein.

In some embodiments, for example, a data transformation may be completed through application of one or more filters to the input image. In some embodiments, for example, a filter may be applied to smooth or blur an image, sharpen an image, enhance a resolution of an image, compress an image, adjust a tonal mapping of an image, and/or otherwise enhance or transform an image. Different filter types or filtering techniques may be used to affect a particular type of enhancement or transformation. Image smoothing, for example, may be performed using a Gaussian filter, an averaging filter, a median filter, an adaptive filter (e.g., based on local image variance), or other known filters or filtering techniques. It will be appreciated that the types of enhancements or transformations that are applied, and the filter types or techniques used to affect them, may vary depending on the embodiment and its application (e.g., based on the nature of the object being detected in the image, the imaging modality used to capture the image, etc.).

In some embodiments, applying a filter to an input image may involve convolution or correlation of one or more filter kernels (or filter masks) with the input image to obtain a transformed image. In some embodiments, for example, a filter kernel may be defined by a number of filter weights, which may be arranged as an array (or matrix) having one or more dimensions (though other structures and arrangements may be possible). The filter kernel may be moved across the image (e.g., element-by-element in each dimension) and a weighted sum of the image elements falling within the filter kernel (e.g., a product of the filter weights and corresponding image element values) may be computed. In the case of convolution, a filter kernel may be flipped before it is moved across the image and the weighted sum is computed. Because a portion of a filter kernel may extend past the edge of an image (e.g., when correlating or convolving the filter kernel with elements near the boundary of an input image), in some embodiments, the input image may be padded with additional values to permit application of a filter kernel. The input image, for example, may be padded with a scalar value (e.g., zero padded), symmetrical values (e.g., across the boundary of the input image), replicated values (e.g., based on a nearest neighbor), circular values (e.g., treating the input image as being periodic in each dimension), or in some other manner.

In some cases, a filter may operate in the spatial domain (e.g., to perform volume filtering) and the one or more filter kernels may be applied (e.g., correlated or convolved) directly to the input image. In some cases, a filter may operate in another domain such as a frequency domain or integral image domain. In such cases, an input image may be converted from one domain (e.g., from a spatial domain) to another (e.g., to a frequency or integral image domain), where a filter may be applied, and then back again (e.g., from the frequency or integral domain back to the spatial domain). For example, where a filter operates in the frequency domain, the image may be converted back and forth between a spatial domain and frequency domain using a Fourier transform (e.g., by applying an n-dimensional fast Fourier transform (FFT) and inverse fast Fourier transform (IFFT)).

In some embodiments, a filter may be defined by one or more parameters. In some embodiments, for example, a filter may be defined by a kernel size (e.g., 5×5, 3×3×3, 3×3×1, etc.) and corresponding filter weights. In some cases, filter weights of a filter kernel may be provided by a function parameterized by one or more variables. A Gaussian filter, for example, may be parameterized by a mean and sigma (or σ) value, specifying a standard deviation of a Gaussian function used to determine filter weights. By way of example, a 2D Gaussian filter having a kernel size of 5×5 and filter values provided by a Gaussian function having a mean value of 0 and sigma value of 1 may take the following form:

$$\frac{1}{273} [ \begin{matrix}1 & 4 & 7 & 4 & 1 \\ 4 & 16 & 26 & 16 & 4 \\ 7 & 26 & 41 & 26 & 7 \\ 4 & 16 & 26 & 16 & 4 \\ 1 & 4 & 7 & 4 & 1\end{matrix} ]$$

In some embodiments, application of a filter may be governed by one or more settings, including for example, an application domain (e.g., spatial, frequency, integral image, etc.), an application method (e.g., convolution, correlation, etc.), a padding method (e.g., numerical, symmetrical, replicate, circular, etc.), and/or one or more additional settings.

In some embodiments, an input image may undergo several data transformations at the data transformation stage 131. For example, as noted previously, in some embodiments a data transformation may be applied to an input image for each of one or more processing iterations. In some embodiments, the same input image may be used for each processing iteration (e.g., without reducing a resolution of an input image or compressing an input image between processing iterations). In some embodiments, the data transformation applied to an input image may depend on the object being detected (e.g., applying a different data transformation for detection of hard tissue than for detection of soft issue). In some embodiments, for instance, anatomical heuristics may be used to determine the data processing operations and/or operation settings and parameters applied to a CT image (or region thereof) (e.g., providing an optimal filter type and kernel size for hard tissue detection in a chest region).

In some embodiments, different data transformations may be applied for different processing iterations, which may enhance or otherwise transform the input image in different ways. In some embodiments, for instance, different data transformations may be applied for each processing iteration, which may allow for a unique portion of an object to be detected (e.g., at object detection stage 132) in each iteration (e.g., relative to other transformed images generated in other processing iterations). In some embodiments, a data transformation stage 131 may be omitted, or may involve applying an identity transformation (e.g., by applying an identity filter or using a Dirac delta function), for an initial processing iteration (or initialization process).

In some embodiments, for example, a different data transformation may be applied for different processing iterations by varying one or more parameters or settings of a data transformation and/or applying a different type of data transformation. In some embodiments, for example, a different filter (or different set of filters) may be applied to an input image for each of one or more processing iterations. For instance, in some embodiments, a different smoothing filter may be applied to an input image for each of one or more processing iterations, with the parameters of the smoothing filter varying between each iteration. For example, in some embodiments, a multi-dimensional Gaussian filter may be applied to an input image for one or more processing iterations, with a kernel size, mean, and/or sigma value varying between processing iterations. In other embodiments, different types of smoothing filters may be applied in one or more processing iterations (e.g., a Gaussian filter, an averaging filter, a median filter, an adaptive filter, etc.). In some embodiments, filters for different enhancements or transformations may be performed in each processing iteration (e.g., smoothing an image in a first iteration, enhancing an image resolution in a second iteration, adjusting a tonal mapping in a third iteration, smoothing and adjusting a tonal mapping of an image in a fourth iteration, etc.).

In some embodiments, application of one or more data transformation(s) at the data transformation stage 131 may be optimized in some manner, for example, for execution speed and/or efficiency. In some embodiments, for example, application of a data transformation may be performed by a particular type of processor or processing unit. In some embodiments, for example, a data transformation may be performed on a parallel processor, such as a GPU, which may be able to accelerate and/or more efficiently execute the data processing operations that affect the data transformation (e.g., relative to their execution on a serial processor, such as a CPU). In some embodiments, where several data transformations are applied to an input image (e.g., for each of one or more processing iterations), further acceleration and/or efficiency may be achieved by performing some or all of the data transformations in parallel (e.g., on one or more processor(s) 102 of computing system 100). In some embodiments, for example, data transformation settings and/or parameters may be known (or determinable) in advance for each data transformation (e.g., for each processing iteration) or for a subset of data transformations (e.g., for a first n processing iterations), allowing them to be performed in parallel. By way of example, in some embodiments, a Gaussian filter may be applied in each processing iteration to smooth an input image, with the kernel size varying between each iteration in a defined manner (e.g., having a kernel size of 3+2(n−1)×3+2(n−1)×3+2(n−1) in an n^{th} iteration). In some embodiments, the number of processing iterations may vary (e.g., where iterative processing continues until a termination criterion is or termination criteria are met). In such embodiments, an initial set of data transformations (e.g., for a minimum number of processing iterations or an estimated number of processing iterations) may be performed in parallel. It may not always be possible to apply multiple data transformations in parallel, and in some embodiments, data transformations may be performed in serial fashion. In some embodiments, for example, the data transformation settings or parameters for a processing iteration (e.g., beyond an initial iteration) may not be known in advance (e.g., until determined at parameter update stage 135 of a previous iteration), and some or all of the data transformations may be performed serially (e.g., as a result of this dependency).

In embodiments where multiple data transformations are applied in parallel, one or more additional operations may be performed to accelerate execution and/or improve efficiency. For example, in applying a data transformation to an input image, a memory allocation operation may be performed to reserve memory needed to perform the data transformation (e.g., to reserve a portion of memory 104 where the transformed image that is generated may be written). The memory allocation operation may be relatively expensive (e.g., increasing processing latency of a processing iteration by multiple orders of magnitude). Accordingly, in some embodiments, a total or maximum amount of memory needed to perform multiple data transformations may be computed or estimated and a single memory allocation operation may be performed (e.g., that reserves a portion of memory 104 where each transformed image that will be generated can be written).

At object detection stage 132, an object detection process may be performed on an input image to obtain an object mask. In some embodiments, for example, an object detection process may be performed on an input image (e.g., a transformed image generated at data transformation stage 131) for each of one or more processing iterations (e.g., generating an object mask in each processing iteration) of an iterative object detection process. The object mask(s) that are generated at object detection stage 132 may be provided to subsequent stages of image processing pipeline 130 (e.g., as an input to output aggregation stage 133).

In some embodiments, a transformed image generated at data transformation stage 131 may be provided as an input to object detection stage 132 for processing. In some embodiments, for instance, a transformed image may be added to a processing queue of object detection stage 132 upon generation at data transformation stage 131. When an image reaches the front of the processing queue, it may be copied to an input buffer (e.g., in memory 104) of object detection stage 132 and the object detection process may begin. Alternatively, in some embodiments, images in the queue may be processed in place (e.g., with the output buffer of data transformation stage 131 being treated as an input buffer of object detection stage 132).

An object detection process may be performed on an input image (e.g., on a transformed image received from data transformation stage 131) to generate an object mask that identifies elements in the input image (e.g., corresponding to elements in a source image from which the transformed image was generated) that represent an object being detected. In some embodiments, for example, an object detection process may operate to modify the elements of the input image to generate the object mask (e.g., by setting the value of elements representing an object to 1 (or a maximum element value) and those that do not represent an object to 0 (or a minimum element value)). In some embodiments, an object mask may have a same size (e.g., a same resolution) as the input image being processed. In some embodiments, the object mask that is generated may be written to an output buffer (e.g., in memory 104). In some embodiments, the object mask may be provided to subsequent stages of image processing pipeline 130 (e.g., as an input to output aggregation stage 133). In some embodiments, for instance, an object mask may be added to a processing queue of another processing stage (e.g., a processing queue of output aggregation stage 133).

In some embodiments, the object detection process may involve one or more data processing operations, which may be performed in accordance with one or more settings or parameters. The object detection technique applied at object detection stage 132 may vary depending on the embodiment and its application (e.g., based on the nature of the object(s) being detected in the image, the imaging modality used to capture the image, the data transformation applied at data transformation stage 131, etc.). By way of example, in some embodiments, the object detection process may involve the following operations: normalizing the input image, generating an intensity histogram from the normalized image, and binarizing the image to obtain an object mask, additional detail for which is provided herein.

In some embodiments, normalizing an input image may operate to scale (or otherwise adjust) the element values of an input image to fall within a desired range (e.g., [0, 1], [−1, 1], [0, 5], etc.). Normalizing an input image may help to facilitate categorization of image elements (e.g., that fall within a range of intensities) and reduce or eliminate noise (e.g., in subsequent processing operations and/or stages). Normalizing an input image, for example, may scale element values into a narrower range (e.g., from [0, 1000] to [0, 10]) such that more elements may fall within an incremental portion of the range, thereby allowing for easier classification of elements into different categories (e.g., as containing or not containing bone). A number of different normalization techniques may be employed depending on the embodiment and its application, including for example, min-max normalization (or rescaling), mean normalization, Z-score normalization (or standardization), or other normalization technique.

In some embodiments, the normalization technique may involve determining a range of element values in an input image (e.g., a minimum and maximum intensity value across all elements of the input image). By way of example, in some embodiments, min-max normalization may be performed using the following equation, to scale voxel intensity values of a 3D image (e.g., with voxel elements arranged in an x, y, and z dimension) to fall within the range [0,1]:

$${img [ x , y , z ]}^{′} = \frac{img [ x , y , z ] - min}{max - min} \qquad Eq . 1$$

where img[x,y,z] is an initial intensity value of a voxel, min is a minimum intensity value (e.g., across all voxels in the image), max is a maximum intensity value (e.g., across all voxels in the image), and img[x,y,z]′ is the normalized intensity value of the voxel. In some embodiments, the min-max normalization affected by Equation 1 may be adapted to scale intensity values to fall within a different range (e.g., range [0, r]) by multiplying the right-hand-side of Equation 1 by a scaling factor (e.g., normalization constant r) as follows:

$${img [ x , y , z ]}^{′} = r * \frac{img [ x , y , z ] - min}{max - min} \qquad Eq . 2$$

In some embodiments, a normalization operation may have one or more parameters, including for example, an applicable normalization function (e.g., Equations 1 or 2), which may be parameterized by one or more of a desired normalized range (e.g., [0, 1], [0, r], etc.), a normalization constant r, and/or an element value range of an input image (e.g., a minimum and maximum element value across all elements of an input image).

In some embodiments, generating an intensity histogram may involve determining a count of image elements having a particular value, or falling within a range of values. The intensity histogram may be used in determining an optimal threshold for image binarization, as described in further detail herein. In some embodiments, a histogram may be generated from a normalized image, for example, by dividing the normalized range (e.g., [0, r]) into a number of bins, each bin representing a certain intensity value or range of values, (e.g., into r bins of width 1) and determining a count of elements in the normalized image whose value falls within each bin. In some embodiments, a histogram generation operation may have one or more parameters, including for example, a bin size or a number of bins.

In some embodiments, binarizing an image may operate to convert image element values, which may take on a range of values (e.g., 8-bit, 10-bit, 16-bit values), into binary values (e.g., of either 0 or 1). In some embodiments, for example, binarization may be performed by thresholding the image element values. In some embodiments, for instance, binarization may performed on a normalized image by applying a threshold value, e.g., a threshold value above which an element value may be set to 1 and below which an element value may be set to 0.

The applicable threshold value may be determined using a number of different techniques depending on the embodiment and its application, including for example, histogram-based methods, clustering-based methods, entropy-based methods, object attribute-based methods (e.g., fuzzy shape similarity, edge coincidence, etc.), spatial methods (e.g., using higher-order probability distributions and/or element correlation), or in some other manner.

In some embodiments, for example, an applicable threshold value may be determined based on an analysis of the intensity histogram of a normalized image. By way of example, in some embodiments, a cutoff value may be determined by identifying the histogram bin having a maximum count and setting the threshold value as the upper or lower bound of the identified bin, an average or median value of the elements within the bin, or in some other manner. In some embodiments, the applicable threshold may be determined based on an iterative analysis of the intensity histogram of the normalized image. In some embodiments, for example, a threshold value may be determined as just described (e.g., by identifying the histogram bin having a maximum count and setting the cutoff value based on the identified bin and/or its elements), which may treated as an initial threshold value that may be refined through an iterative adjustment process.

In some embodiments, for instance, a determination may be made regarding the number of image elements that would be captured by the threshold value (e.g., a number of elements whose value falls between the threshold value and a maximum bin size inclusively) and/or a percentage of image elements that would be captured by the threshold value (e.g., relative to a total number of image elements). In some embodiments, a determination may then be made as to whether the number and/or percentage of image elements captured fall within a desired range (e.g., between a minimum and maximum amount or percentage). If the number and/or percentage fall within the desired range, the threshold value may be deemed satisfactory and may be used to binarize the image. If not, the threshold value may be adjusted, for example, by incrementing or decrementing the cutoff value by a refinement factor δ (e.g., if the number and/or percentage of elements exceeded or fell below the desired range, respectively). The process may then be repeated using the adjusted threshold value.

In some embodiments, the process may repeat until a satisfactory threshold value is identified or a maximum number of iterations is reached without success (e.g., beyond which further adjustment may result in an overly inclusive threshold value). In some embodiments, the maximum number of iterations may be a fixed number of iterations and/or determined in some other manner (e.g., based on the number of bins in the histogram). For instance, in some embodiments, the maximum number of iterations may be determined using the following equation:

$$max = 4 + \frac{num\_bins}{10} \qquad Eq . 3$$

where num_bins is the number of bins in the histogram and max is the maximum number of iterations that may be performed.

In some embodiments, an image binarization operation may have one or more parameters, which may include parameters used in a threshold value determination process. For example, where an iterative threshold determination process is performed, parameters may include a maximum number of iterations, a satisfactory range for a number and/or percentage of capture image elements, and/or an adjustment amount 8. In some embodiments, the results of the image binarization operation may serve as the object mask generated by the object detection process. In some embodiments, an empty or negative object mask (e.g., where each element value is 0) may be returned if a satisfactory cutoff value is not identified.

In some embodiments, an object detection process may be applied to multiple input images at the object detection stage 132. For example, as previously noted, in some embodiments, an object detection process may be performed on an input image for each of one or more processing iterations of an iterative object detection process. In some embodiments, for example, an object detection process may be performed on each transformed image generated at data transformation stage 131 (e.g., for each of one or more processing iterations of an iterative object detection process). Each object mask that is generated may identify elements (e.g., corresponding to elements in a source image) that represent one or more objects under detection (or portions thereof). In some embodiments, the object detection process applied to an input image may depend on the object being detected (e.g., applying a different object detection process for detection of hard tissue than for detection of soft issue). In some embodiments, for instance, anatomical heuristics may be used to determine the data processing operations and/or operation settings and parameters applied to a transformed CT image (or region thereof) (e.g., providing an optimal normalization range for a normalization operation, an optimal maximum number of iterations for an iterative threshold determination process, etc.).

In some embodiments, different object detection processes may be performed in different processing iterations. In some embodiments, the object detection process performed in different processing iterations may have different settings or parameters and/or involve different techniques. In some embodiments, for example, one or more parameters of a normalization operation, a histogram generation operation, and/or an image binarization operation may be varied in different processing iterations. For instance, in some embodiments, a normalization technique and/or a normalized range for a normalization operation may be varied in different processing iterations (e.g., by employing a different normalization function and/or utilizing a different normalization constant r). Likewise, in some embodiments, a number of bins and/or a bin size for a histogram generation operation may be varied in different processing iterations. In some embodiments, for an image binarization operation, the method of determining an applicable threshold and/or one or more parameters of a threshold determination process may be varied in different processing iterations. For example, in some embodiments, a maximum number of iterations, a satisfactory range for a number and/or percentage of capture image elements, and/or a refinement factor δ may be varied for a threshold determination process in different processing iterations.

In some embodiments, the performance of one or more object detection process(es) at the object detection stage 132 may be optimized in some manner, for example, for execution speed and/or efficiency. In some embodiments, for example, an object detection process (including some or all of the operations or processes involved therein) may be performed by a particular type of processor or processing unit. In some embodiments, for example, an object detection process may be performed on a parallel processor, such as a GPU, which may be able to accelerate and/or more efficiently execute operations and processes involved therein (e.g., relative to their execution on a serial processor, such as a CPU). In some embodiments, where several object detection processes are performed (e.g., on an input image for each of one or more processing iterations) further acceleration and/or efficiency may be achieved by performing some or all of the object detection processes in parallel (e.g., on one or more processor(s) 102 of computing system 100). In some embodiments, for example, where the settings and/or parameters for each object detection process (e.g., for each processing iteration) or a subset of processes (e.g., for a first n processing iterations) are known (or are determinable) in advance, and the input images on which they may be performed exist (e.g., have been generated in parallel at data transformation stage 131), some or all of the object detection processes may be performed in parallel.

It may not always be possible to perform multiple object detection processes in parallel, and in some embodiments, one or more object detection processes may be performed in serial fashion. In some embodiments, for example, the settings or parameters for a processing iteration (e.g., beyond an initial iteration) may not be known in advance (e.g., until determined at parameter update stage 135 of a previous iteration), or an input image on which an object detection process is to be performed may not be available (e.g., until generated at data transformation stage 131), and some or all of the object detection processes may be performed serially (e.g., as a result of these dependencies).

In embodiments where multiple object detection processes are performed in parallel, one or more additional operations may be performed to accelerate execution and/or improve efficiency. For example, in some embodiments, an object detection process may involve performing a memory allocation operation to reserve the memory needed to perform the process (e.g., to reserve a portion of memory 104 where an object detection mask may be written). The memory allocation operation may be relatively expensive (e.g., increasing processing latency of a processing iteration by multiple orders of magnitude). Accordingly, in some embodiments, a total or maximum amount of memory needed to perform multiple object detection processes may be computed or estimated and a single memory allocation operation may be performed (e.g., that reserves a portion of memory 104 where each object detection can be written).

At output aggregation stage 133, an input object mask (or input mask) may be processed to create and/or update a combined object mask. In some embodiments, for example, an object mask may be merged into a combined object mask for each of one or more processing iterations of an iterative object detection process. In embodiments where an image is divided into one or more regions of interest (e.g., one or more sub-images) that are separately processed (e.g., in separate instances of stages 131-132), a combined object mask may be created and/or updated for each region of interest (e.g., merging object masks generated from a particular sub-image) and/or the image as a whole (e.g., merging object masks generated across sub-images). By way of example, where a CT image is divided into one or more regions of interest (e.g., a chest region, abdominal region, etc.), a combined object mask may be created and/or updated for each region of interest and/or the body as a whole. In some embodiments, only the unique elements of an input mask may be merged into the combined object mask. In some embodiments, statistical information may be collected with regard to an input mask that is processed, including for example, a unique element count of the input mask and/or a total element count of the combined object mask (e.g., prior to and/or following the merge). The combined object mask and collected statistical information may be provided to subsequent stages of image processing pipeline 130 (e.g., to object selection stage 136 and output evaluation stage 134, respectively).

In some embodiments, an object mask generated at object detection stage 132 may be provided as an input to output aggregation stage 133 for processing. In some embodiments, for instance, an object mask may be added to a processing queue of output aggregation stage 133 upon generation of the object mask at object detection stage 132. When an object mask reaches the front of the processing queue, it may be copied to an input buffer (e.g., in memory 104) of output aggregation stage 133 and processing may begin. Alternatively, in some embodiments, object masks in the queue may be processed in place (e.g., with the output buffer of object detection stage 132 being treated as an input buffer of output aggregation stage 133). In some embodiments, the combined object mask may be written to (and updated in) an output buffer (e.g., in memory 104). The combined object mask may be provided to subsequent stages of image processing pipeline 130 (e.g., as an input to object selection stage 136). In some embodiments, statistical information regarding the processing of an object mask may be recorded in an output buffer (e.g., in memory 104). The statistical information that is collected may be provided to subsequent stages of image processing pipeline 130 (e.g., as an input to output evaluation stage 134).

In some embodiments, an input mask may be processed to create and/or update a combined object mask. By way of example, in an initial case (e.g., in processing an object mask of a first processing iteration), an input mask may be used to create and/or initialize a combined object mask (e.g., which may not have existed or may have been empty prior thereto). Thereafter, an input mask may be compared to an existing combined object mask to identify unique elements in the input mask (e.g., not present in the combined object mask). The unique elements that are identified may be merged into the combined object mask and, in some embodiments, may optionally be captured as a differential mask (e.g., in an output buffer in memory 104). It may be the case that no unique elements exist in an input mask, in which case, no changes may be made to the combined object mask and the differential mask that may be optionally captured may be empty.

In some embodiments, statistical information may be collected when processing an input mask. In some embodiments, for example, a count of the unique elements identified in an input mask and/or a count of elements in the combined object mask (e.g., before and/or after the unique elements have been merged into the combined object mask) may be recorded (e.g., for each processing iteration of an iterative object detection process). In some embodiments, a combined object mask may be divided into one or more regions (e.g., corresponding to one or more regions of interest in a source image) and statistical information may be collected with respect to some or all of the regions. In some embodiments, for example, a count of the unique elements identified in each region of the input mask and/or a count of elements in each region of the combined object mask may be recorded (e.g., for each processing iteration of an iterative object detection process).

In some embodiments, processing of object masks at the output aggregation stage 133 may be optimized in some manner, for example, for execution speed and/or efficiency. In some embodiments, for example, processing of an object mask to create and/or update a combined object mask may be performed by a particular type of processor or processing unit. In some embodiments, for example, processing the object mask may be performed on a parallel processor, such as a GPU, which may be able to accelerate and/or more efficiently execute the operations, including for example, the comparison and/or merge operations, that are performed (e.g., relative to their execution on a serial processor, such as a CPU).

At output evaluation stage 134, a termination criterion (or criteria) may be evaluated to determine whether processing of an image (e.g., a source image or sub-image thereof) is complete or if processing should continue (e.g., with another processing iteration), based on which processing at one or more other stages in image processing pipeline 130 may be initiated (e.g., at parameter update stage 135 or object selection stage 136). In some embodiments, statistical information (e.g., collected at output evaluation stage 133) regarding one or more object masks (e.g., generated at object detection stage 132) and/or a combined object mask (e.g., created and updated at output aggregation stage 133) may be received as an input and used in evaluating the termination criterion or criteria.

In some embodiments, for example, termination criteria may specify a maximum number of processing iterations that may be performed in processing a source image. For instance, in some embodiments, termination criteria may specify that no more than fifteen processing iterations are to be performed. Accordingly, in some embodiments, a current processing iteration may be determined and compared to the maximum specified in the termination criteria to determine whether it has been satisfied (e.g., whether a maximum number of processing iterations have been performed). If satisfied, a determination may be made that processing of the source image is complete.

In some embodiments, the termination criteria may specify a minimum number of processing iterations that are to be performed in processing a source image. For instance, in some embodiments, termination criteria may specify that at least five processing iterations are to be performed. In some embodiments, a current processing iteration may be determined and compared to the minimum specified in the termination criteria to determine whether it has been satisfied (e.g., whether a minimum number of processing iterations have been performed). In some embodiments, if the minimum number of processing iterations is not satisfied, no additional termination criteria may be evaluated and/or considered.

In some embodiments, the termination criteria may specify a minimum amount of object (e.g., on the whole and/or with respect to one or more regions) to be newly added (e.g., to a combined object mask) in a processing iteration. For instance, in some embodiments, the termination criteria may specify that a minimum percentage of elements is to be added (e.g., 0.1% additional elements in each region) in one or more processing iterations. In some embodiments, the minimum amount specified in the termination criteria may vary for different processing iterations. In some embodiments, the termination criteria may specify a number of iterations that may fail before processing is considered complete, and optionally specify whether the iterations are to be consecutive or can be nonconsecutive. As an illustrative example, termination criteria may specify that processing of a source image is complete if a minimum percentage of elements is not added in two consecutive processing iterations (e.g., 0.1% additional elements in a previous processing iteration and 1% additional elements in the processing iteration immediately prior thereto).

The amount of object newly identified or added (e.g., on the whole and/or with respect to one or more regions) in one or more previous iterations may be determined based on the received statistical information and compared to the termination criteria. In some embodiments, for example, a percentage of elements added may be computed from the statistical information (e.g., as a ratio of the count of the unique elements identified in an object mask (or region therein) to the count of elements in the combined object mask (or region therein)) for each processing iteration, which may then be compared to the termination criteria.

In some embodiments, the termination criteria that is applied may depend on the object being detected (e.g., applying a different data transformation for detection of hard tissue than for detection of soft issue). In some embodiments, for instance, anatomical heuristics may be used to determine the termination criteria applied when processing a CT image (or region thereof) (e.g., providing an optimal number of iterations that may fail before processing is considered complete).

If termination criteria are satisfied (e.g., if a minimum number of processing iterations has been performed, a maximum number of processing iterations has been reached, and/or an amount of object is not identified or added in one or more previous iterations), a determination may be made that processing of the source image is complete and processing at object selection stage 136 may be initiated (e.g., by sending or triggering an enable signal). If no termination criteria are satisfied (e.g., if a minimum number of iterations has not been reached, or a maximum number of iterations has not been reached and a minimum amount of object has been newly identified or added), a determination may be made that processing of the source image should continue and processing at parameter update stage 135 may be initiated (e.g., by sending or triggering an enable signal).

At parameter update stage 135, a signal may be received (e.g., from output evaluation stage 134) indicating that a source image should undergo an additional processing iteration. In response to the signal, one or more settings or parameters for operations or processes performed in data transformation stage 131 and/or objection detection stage 132 may be updated, and an additional processing iteration may be initiated (e.g., by sending an enable signal to data transformation stage 131). In some embodiments, the settings or parameters that are updated and the manner in which they are updated may depend on the object being detected. In some embodiments, for instance, anatomical heuristics may be used to determine the setting or parameter updates to be made when processing a CT image (or region thereof) (e.g., providing an optimal change in kernel size to facilitate detection of unique portions of an object in each iteration). Additional detail regarding the settings or parameters that may be adjusted in different processing stages is provided throughout the present disclosure.

In some embodiments, for example, a different filter (or different set of filters) may be applied to an input image for each of one or more processing iterations at data transformation stage 131. For instance, in some embodiments, a different smoothing filter may be applied to an input image for each of one or more processing iterations, with the parameters of the smoothing filter varying between each iteration. For example, in some embodiments, a multi-dimensional Gaussian filter may be applied to an input image for one or more processing iterations, with a kernel size, mean, and/or sigma value varying between processing iterations. For instance, in some embodiments, a Gaussian filter may be applied in each processing iteration to smooth an input image, with the kernel size varying between each iteration in a defined manner (e.g., having a kernel size of 3+2(n−1)×3+2(n−1)×3+2(n−1) in an n^{th} iteration).

In some embodiments, the object detection process performed in different processing iterations at object detection stage 132 may have different settings or parameters and/or involve different techniques. In some embodiments, for example, one or more parameters of a normalization operation, a histogram generation operation, and/or an image binarization operation in an object detection process may be varied in different processing iterations. For instance, in some embodiments, a normalization technique and/or a normalized range for a normalization operation may be varied in different processing iterations (e.g., by employing a different normalization function and/or utilizing a different normalization constant r). Likewise, in some embodiments, a number of bins and/or a bin size for a histogram generation operation may be varied in different processing iterations (e.g., determined based on the normalization constant r used in a normalization operation). In some embodiments, the parameters of an iterative threshold determination process in an image binarization operation may be varied in different processing iterations. For example, in some embodiments, a maximum number of iterations, a satisfactory range for a number and/or percentage of capture image elements, and/or a refinement factor δ of an iterative threshold determination process may be varied in different processing iterations.

At object selection stage 136, an input object mask may be processed to segment elements therein into one or more groups, each of which may represent an object. In some embodiments, for example, an input signal may be received (e.g., an enable signal from output evaluation stage 134), in response to which a combined object mask (e.g., from output aggregation stage 133) may be processed to segment elements therein into one or more groups, each of which may represent an object. In some embodiments, one or more groups may be selected to include in a final object identification mask. In some embodiments, an input object mask may be divided into one or more regions, and each region may be separately processed (e.g., to segment the elements in a region into one or more groups and to select one or more of the groups for inclusion in the final object detection mask). The final object identification mask may serve as the output of image processing pipeline 130.

In some embodiments, the combined object mask created and maintained by output aggregation stage 133 may be provided as an input to output selection stage 136. In some embodiments, for example, upon receipt of an input signal (e.g., an enable signal from output evaluation stage 134) indicating that processing of a source image is complete, the combined object mask may be copied to an input buffer (e.g., in memory 104) of output selection stage 136 and processing may begin. Alternatively, in some embodiments, the combined object mask may be processed in place (e.g., with the output buffer of output aggregation stage 133 being treated as an input buffer of output selection stage 136). In some embodiments, a segmented object mask, in which elements of the combined object mask have been grouped and labeled, may be stored in an output buffer (e.g., in memory 104). Likewise, in some embodiments, a final object identification mask may be stored in an output buffer (e.g., in memory 104).

In some embodiments, an object mask (e.g., a combined object mask generated at output aggregation stage 133) may be processed to segment object elements (e.g., elements having a value of 1 (or a maximum element value)) therein into one or more groups to create an object segmentation mask. In some embodiments, different groups of elements may be assigned a distinct label (e.g., by assigning distinct values to different groups of elements) in the object segmentation mask.

A number of different segmentation techniques may be used to process an input object mask and generate an object segmentation mask, with the chosen technique depending on the embodiment and its application. In some embodiments, for example, a connected component identification technique may be employed to group spatially connected elements into one or more groups, each of which may represent a distinct object (e.g., spatially disconnected object). In some embodiments, for example, a connected component identification technique may involve performing a region growing process to group spatially connected elements in a combined object mask. Seed selection for the region growing process may be determined based on different criterion. In some embodiments, for example, seed selection may be based on a spatial location of an element within the object mask. In some cases, for instance, seed elements may be identified as the first element encountered when traversing the object mask in one or more dimensions (e.g., a left-to-right, top-to-bottom, and/or front-to-back scan). In some embodiments, seed selection may be based on corresponding image element values (e.g., identifying seed elements in the object mask where corresponding values in the input image fall within a particular range).

In some embodiments, the region growing operation may be performed natively on the combined object mask (e.g., in an image space), while in other embodiments, it may operate in an alternate space (e.g., a graph space). In the latter case, the input object mask may be encoded into the alternate space (e.g., from an image space to a graph space), where the region growing operation may be performed, and then decoded back again (e.g., from the graph space to an image space). By way of example, a combined object mask in its native form may include a set of image elements (e.g., pixels or voxels) spatially arranged in a number of dimensions. In some embodiments, the combined object mask may be encoded into a graph space, where the combined object mask may be represented as a graph in which the elements of the combined object mask are vertices and the edges in the graph represent the spatial relationship between elements. In some embodiments, the region growing process may identify spatially connected elements by performing a breadth first traversal in an encoded space (e.g., a graph space). In some embodiments, the different groups of elements may be labeled in some manner (e.g., by assigning distinct values to different groups of elements) to create an object segmentation mask.

In some embodiments, one or more groups of elements may be selected from the object segmentation mask based on certain selection criteria for inclusion in a final detected object mask. In some embodiments, for example, a selection criterion may specify that the largest group (or n largest groups) in the object segmentation mask is (or are) included in a final detected object mask. As an illustrative example, in processing a high-resolution CT image, an object segmentation mask may be generated that includes include groups of elements corresponding to a bone structure and a CT scanning apparatus (e.g., a cradle for the head of a patient, etc.). It may be expected that the bone structure will be the largest detected object, corresponding to the largest group of elements in the object segmentation mask. A selection criterion specifying the selection of the largest group of elements, thus, may operate to select the bone structure (to the exclusion of the CT scanning apparatus) as the final detected object. It will be appreciated that different selection criteria may be used depending on the embodiment and its application.

In some embodiments, the segmentation technique that is applied may depend on the object being detected (e.g., applying a different segmentation technique for detection of hard tissue than for detection of soft issue). In some embodiments, for instance, anatomical heuristics may be used to determine the segmentation technique applied to an object mask (or region thereof) (e.g., providing an optimal selection technique for detecting whole body bone structure or optimal selection criteria for selecting groups of elements for inclusion in the final detected object mask).

In some embodiments, processing of an input object mask (e.g., a combined object mask) at the output selection stage 136 may be optimized in some manner, for example, for execution speed and/or efficiency. In some embodiments, for example, encoding an object mask into an alternate space, performing a region growing process to segment and label groups of elements in the object mask, and decoding the segmentation mask back into a native space may be performed by a particular type of processor or processing unit, which may result in accelerated and/or more efficient execution. In some embodiments, for example, encoding an object mask and decoding the segmentation mask may be performed on a parallel processor, such as a GPU, while the region growing process may be executed on a serial processor, such as a CPU.

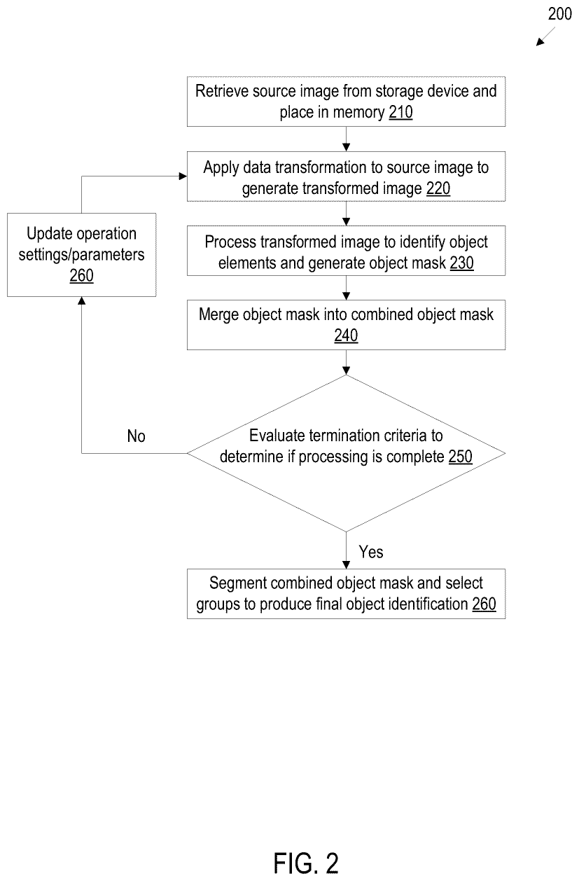

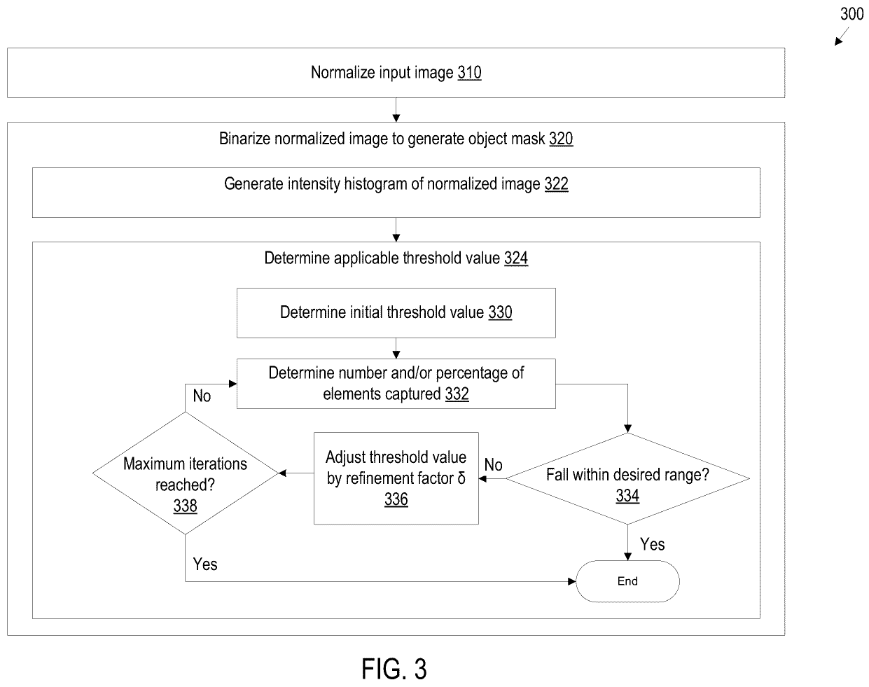

FIGS. 2-3 illustrate flow diagrams of example methods according to some embodiments. For the sake of simplicity and clarity, the methods are depicted and described as a series of operations. However, in accordance with the present disclosure, such operations may be performed in other orders and/or concurrently, and with other operations not presented or described herein. Furthermore, not all illustrated operations may be required in implementing methods in accordance with the present disclosure. Those of skill in the art will also understand and appreciate that the methods could be represented as a series of interrelated states or events via a state diagram. Additionally, it will be appreciated that the disclosed methods are capable of being stored on an article of manufacture. The term “article of manufacture,” as used herein, is intended to encompass a computer-readable device or storage media provided with a computer program and/or executable instructions that, when executed, affect one or more operations.

FIG. 2 illustrates a flow diagram of an example method 200 for performing object detection and segmentation, according to at least one embodiment. The method 200 may be performed by processing logic of a computing device (e.g., using processor(s) 102 of computing system 100 shown in FIG. 1). In method 200, an object detection and segmentation process may be performed in which a source image is iteratively processed to identify one or more objects of interest in the source image. In some embodiments, for example, an image may be iteratively processed to detect a portion of one or more objects in each iteration. The results of each iteration may be combined and then segmented into groups of elements that correspond to one or more objects in the source image. One or more groups of elements may be selected from the segmented results, which may correspond to particular objects of interest, to produce a final object identification.

At a high level, method 200 may involve retrieving a source image from a storage device and placing it into memory (e.g., at operation 210). The source image may then undergo an iterative object detection process in which a portion of one or more objects may be detected in each iteration. In some embodiments, for example, each iteration may involve applying a data transformation to the source image to generate a transformed image (e.g., at operation 220) and processing the transformed image to generate an object mask (e.g., at operation 230), identifying elements that correspond to one or more objects captured in the source image. The object mask may then be merged into a combined object mask (e.g., at operation 240). After each iteration, termination criteria may be evaluated to determine whether processing is complete or whether another processing iteration should be performed (e.g., at operation 250). If a determination is made that processing should continue, one or more operation settings or parameters may be updated (e.g., at operation 260) and a next processing iteration begin (e.g., back at operation 210). If a determination is made that object detection processing is complete, the combined object mask may be segmented into one or more objects, some (or all) of which may be selected to produce a final object identification mask (e.g., at operation 270).

More particularly, at operation 210, processing logic may be used to retrieve a source image (e.g., that captures one or more objects for detection) from a storage device (e.g., from an image database or repository on mass storage device 106) and place the source image into memory for processing (e.g., into a buffer in memory 104). In some embodiments, the image may be made up of one or more elements in a particular arrangement (e.g., a spatial arrangement having a number of picture elements in each of one or more dimensions). Each element of the image may convey certain information, which may be defined by a format of the image. The image format, for example, may indicate a number and type of values conveyed for each element and a corresponding value size. For illustrative purposes, the source image may be a high-resolution CT image having a resolution of 2048×2048×2048 voxels, where each voxel contains a 16-bit grayscale intensity value.

At operation 220, processing logic may apply a data transformation to the source image (e.g., retrieved at operation 210) for a processing iteration to generate a transformed image for the processing iteration. In some embodiments, for example, a data transformation may operate to modify the elements of the input image to generate the transformed image. In some embodiments, the data transformation applied to the source image may enhance or otherwise transform the source image, for example, to facilitate detection of objects captured therein (e.g., relative to processing of the input image itself).

In some embodiments, the data transformation may be implemented through application of one or more filters to the source image. In some embodiments, for example, a smoothing filter (e.g., a Gaussian filter) may be applied to smooth or blur the source image. In some embodiments, a filter applied to the source image may be defined by one or more filter parameters, including for example, a kernel size and filter weights. A Gaussian filter, for example, may be parameterized by a kernel size, and a mean and sigma (or σ) value, specifying a mean and standard deviation of a Gaussian function used to determine filter weights. In some embodiments, application of a filter may be governed by one or more settings, including for example, an application domain (e.g., spatial, frequency, integral image, etc.), an application method (e.g., convolution, correlation, etc.), a padding method (e.g., numerical, symmetrical, replicate, circular, etc.), and/or one or more additional settings. For illustrative purposes, a 3D Gaussian filter having a kernel size of 3×3×3 and filter values provided by a Gaussian function having a mean value of 0 and a sigma value of 5 may be applied to a source image (e.g., the high-resolution 3D CT image previously described) through convolution in a spatial domain using symmetrical padding; the transformed image that is generated may have the same size and be in a same format as the source image.

In some embodiments, the data transformation applied to the source image may vary depending on the processing iteration. The various data transformations may enhance or otherwise transform the source image in different ways, which for example, may allow for a unique portion of an object to be detected in each iteration (e.g., relative to other transformed images generated in other processing iterations). In some embodiments, for example, a different data transformation may be applied for different processing iterations by varying one or more parameters or settings of a data transformation. In some embodiments, for instance, a different filter may be applied to the source image in each processing iteration (e.g., by varying a kernel size or filter weights in each iteration). For illustrative purposes, a Gaussian filter (e.g., similar to that previously described) may be applied in each processing iteration to smooth the source image, with the kernel size varying between each iteration in a defined manner (e.g., having a kernel size of 3+2(n−1)×3+2(n−1)×3+2(n−1) in an n^{th} iteration). In some embodiments, a data transformation may be skipped, or may involve applying an identity transformation (e.g., by applying an identity filter or using a Dirac delta function), for an initial processing iteration (or initialization process).

At operation 230, processing logic may perform an object detection process on a transformed image (e.g., generated at operation 220) for a processing iteration to obtain an object mask. The object mask may identify elements that correspond to object(s) captured in the source image. In some embodiments, for example, the object detection process may operate to modify the elements of the transformed image to generate the object mask (e.g., by setting the value of elements representing an object to 1 (or a maximum element value) and those that do not represent an object to 0 (or a minimum element value)).

In some embodiments, the object detection process may involve one or more data processing operations, which may be performed in accordance with one or more settings or parameters. In some embodiments, for example, the object detection method of FIG. 3 may be used to process the transformed image to obtain an object mask. At a high level, the method may involve: normalizing the transformed image and binarizing the normalized image to obtain an object mask. In some embodiments, the binarization operation may be performed using a thresholding technique, where an applicable threshold is determined through an iterative analysis of an intensity histogram of the normalized image.

In some embodiments, the object detection process performed on the transformed image may vary depending on the processing iteration. In some embodiments, for example, a different object detection process may be performed for different processing iterations by varying one or more parameters or settings of an object detection process. In some embodiments, for example, one or more parameters or settings of the object detection method of FIG. 3 may be varied, including for example, one or more parameters of the normalization and/or binarization operations.

At operation 240, processing logic may process an object mask (e.g., generated at operation 230) for a processing iteration to merge the object mask into a combined object mask. In some embodiments, only the unique elements of the object mask may be merged into the combined object mask. In some embodiments, statistical information may be collected with regard to the merge process, including for example, a unique element count of the object mask and a total element count of the combined object mask (e.g., prior to and/or following the merge).

By way of example, in some embodiments, processing an object mask of a first processing iteration may involve creating a combined object mask and initializing the combined object mask with the object mask being processed (e.g., merging all elements of the object mask being processed into the combined object mask). Thereafter, an object mask (e.g., of a second processing iteration and beyond) may be compared to an existing combined object mask (e.g., resulting from a previous processing iteration) to identify unique elements in the object mask being processed. The unique elements that are identified may then be merged into the combined object mask. In some cases, no unique elements may be identified in the object mask of a processing iteration, in which case no changes may be made to the combined object mask in that processing iteration. In some embodiments, a count of the unique elements identified in the object mask and a count of elements in the combined object mask may be recorded in memory (e.g., in a buffer in memory 104).

At operation 250, processing logic may evaluate termination criteria to determine whether processing of the source image is complete or if processing should continue with another processing iteration. In some embodiments, statistical information regarding the object mask and combined object mask that may have been collected (e.g., at operation 240) may be used in evaluating the termination criteria. In some embodiments, for example, termination criteria may specify a maximum number of processing iterations that may be performed and/or a minimum amount of elements that are to be newly added (e.g., a minimum number of elements or a minimum percentage of elements) in a current processing iteration (and in some cases, one or more previous processing iterations). In some embodiments, the minimum amount specified in the termination criteria may vary for different processing iterations. In some embodiments, the termination criteria may specify a number of iterations that may fail before processing is considered complete, and optionally specify whether the iterations are to be consecutive or can be nonconsecutive. For illustrative purposes, and without limitation, termination criteria may specify that processing of a source image is complete if twelve or more processing iterations have been performed and/or a minimum percentage of newly added elements (e.g., 0.1%) is not met for two (consecutive or non-consecutive) processing iterations.

If no termination criteria are satisfied, a determination may be made that processing of the source image should continue with another processing iteration (e.g., at operation 220 after updating parameters at operation 260). Alternatively, if any termination criterion is satisfied, a determination may be made that the object detection process is complete and that the method should proceed with object segmentation and selection (e.g., at operation 270).

At operation 260, upon determining that the object detection process should continue with another iteration (e.g., at operation 250), processing logic may update one or more operation settings or parameters and initiate a next processing iteration (e.g., at operation 220). In some embodiments, for example, operation settings or parameters for a data transformation (e.g., performed at operation 220) and/or an object detection process (e.g., performed at operation 230) may be updated for use in the next processing iteration.

At operation 270, upon determining that processing is complete, the combined object mask (e.g., resulting from the last processing iteration of operation 240) may be processed to segment elements therein into one or more groups, some (or all) of which may be selected for inclusion in a final object identification mask. In some embodiments, for example, an object segmentation technique may be employed to group object elements (e.g., elements having a value of 1 (or a maximum element value)) in the combined object mask into one or more groups, where each group may represent a different object (e.g., in the source image being processed). In some embodiments, a connected component identification technique may be employed to group and label spatially connected elements to obtain an object segmentation mask. In some embodiments, the connected component identification technique may involve: encoding the combined object mask into an alternate space (e.g., a graph space), performing a region growing process in the alternate space to identify and label groups of spatially connected elements, and decoding the grouped and labeled results back to a native space (e.g., an image space). In some embodiments, one or more groups of elements may be selected from the object segmentation mask based on certain selection criteria for inclusion in a final object detection mask. A selection criterion, for example, may specify that the largest group of elements in the object segmentation mask is to be selected for inclusion in a final object detection mask (e.g., to the exclusion of other groups of elements). The final object detection mask may serve as the output of method 200.

FIG. 3 illustrates a flow diagram of an example method 300 for performing object detection, according to at least one embodiment. The method 300 may be performed by processing logic of a computing device (e.g., using processor(s) 102 of computing system 100 shown in FIG. 1). In method 300, an object detection process may be performed on an input image to obtain an object mask, identifying elements in the input image that correspond to an object. At a high level, method 300 may involve: normalizing the input image (e.g., at operation 310) and binarizing the normalized image to obtain an object mask (e.g., at operation 320). In some embodiments, the binarization operation may be performed using a thresholding technique, where an applicable threshold is determined through an iterative analysis (e.g., at block 324, including sub-blocks 330-336) of an intensity histogram of the normalized image (e.g., generated at block 322).

More particularly, at operation 310 processing logic may normalize an input image by scaling (or otherwise adjusting) the element values of the input image to fall within a desired range (e.g., [0, 1], [−1, 1], [0, 5], etc.). A number of different normalization techniques may be employed depending on the embodiment and its application, including for example, min-max normalization (or rescaling). In min-max normalization, the range of element values in the input image may be determined (e.g., by finding a minimum and maximum value amongst all elements of the input image), based on which the input image values may be adjusted to fall within a desired range. For example, in some embodiments, the following generalized formula may be used to perform min-max normalization to adjust values to fall within the range [a, b]:

$${element}^{′} = a + \frac{( element - min ) ( b - a )}{max - min} \qquad Eq . 4$$

where element is an initial value of an input image element, min is a minimum value (e.g., across all elements in the input image), max is a maximum value (e.g., across all elements in the input image), a and b are the upper and lower bound of the desired normalized range, and element′ is the normalized value of the input image element. In some embodiments, the desired normalized range may be [0, r], where r is a normalization constant. In such cases, Equation 4 may reduce to:

$${element}^{′} = r * \frac{( element - min )}{max - min} \qquad Eq . 5$$

In some embodiments, the normalization operation may have one or more parameters, including for example, an applicable normalization function (e.g., Equations 4 or 5), which may be parameterized by a desired normalized range (e.g., [a, b], [0, r], etc.), and/or an element value range (e.g., a minimum and maximum intensity value of an input image).

At operation 320, processing logic may binarize the normalized image (e.g., obtained at operation 310), for example, by converting the normalized image values (e.g., falling within a normalized range) into binary values (e.g., of either 0 or 1). In some embodiments, for example, binarization may be performed by thresholding the element values of the normalized image by applying a threshold value (e.g., setting the element value to 1 (or a maximum element value) if it is above the threshold value and setting the element value to 0 (or a minimum element value) if it falls below the threshold value). The applicable threshold value may be determined using a number of different techniques depending on the embodiment and its application, including for example, histogram analysis-based methods. In some embodiments, for example, an applicable threshold may be determined based on an analysis of the intensity histogram of a normalized image.

At block 322, processing logic may generate an intensity histogram from a normalized image (e.g., obtained at operation 310). In some embodiments, a histogram may be generated from the normalized image, for example, by dividing the normalized range (e.g., [0, r]) into a number of bins, each bin representing a certain intensity value or range of values, (e.g., into r bins of width 1) and determining a count of elements in the normalized image whose value falls within each bin. In some embodiments, the histogram generation operation may have one or more parameters, including for example, a bin size or a number of bins.

At block 324, processing logic may determine an applicable threshold value based on an iterative analysis of the normalized image intensity histogram (e.g., generated at block 322). In some embodiments, for example, at sub-block 330, an initial threshold value may be determined by identifying the histogram bin having a maximum count and setting the initial threshold value as the upper or lower bound of the identified bin, or an average or median value of the elements within the bin.

At sub-block 332, processing logic may determine the number and/or percentage of elements in the normalized image that would be captured by the threshold value.

At sub-block 334, processing logic may determine whether the number and/or percentage of elements captured (e.g., determined at sub-block 332) falls within a desired range (e.g., between a minimum and maximum amount or percentage). If the number and/or percentage fall within the desired range, the threshold value may be deemed satisfactory and may be used to binarize the image.

At sub-block 336, if the number and/or percentage do not fall within the desired range, the threshold value may be adjusted by incrementing or decrementing the threshold value by a refinement factor δ (e.g., if the number and/or percentage of elements exceeded or fell below the desired range, respectively).

At sub-block 338, processing logic may determine whether a maximum number of iterations has been reached, which in some embodiments, may be a fixed number of iterations or determined based on the number of bins in the histogram (e.g., using Equation 3). If a maximum number of iterations has not been reached, the sub-process may repeat with the adjusted cutoff value (e.g., at 332). Alternatively, if a maximum number of iterations is reached without identification of a satisfactory threshold value, the sub-process may exit and no binarization operation may be performed, with an empty or negative object mask (e.g., where each element value is 0) being returned instead.

In some embodiments, the binarization operation may have one or more parameters, including for example, one or more parameters used to generate an intensity histogram and/or determine an applicable threshold value. In some embodiments, for example, the histogram generation operation may have one or more parameters, including for example, a bin size or a number of bins. Likewise, in embodiments where an iterative threshold value determination process is performed, the parameters may include a maximum number of iterations, a satisfactory range for a number and/or percentage of capture image elements, and/or an adjustment amount 8.

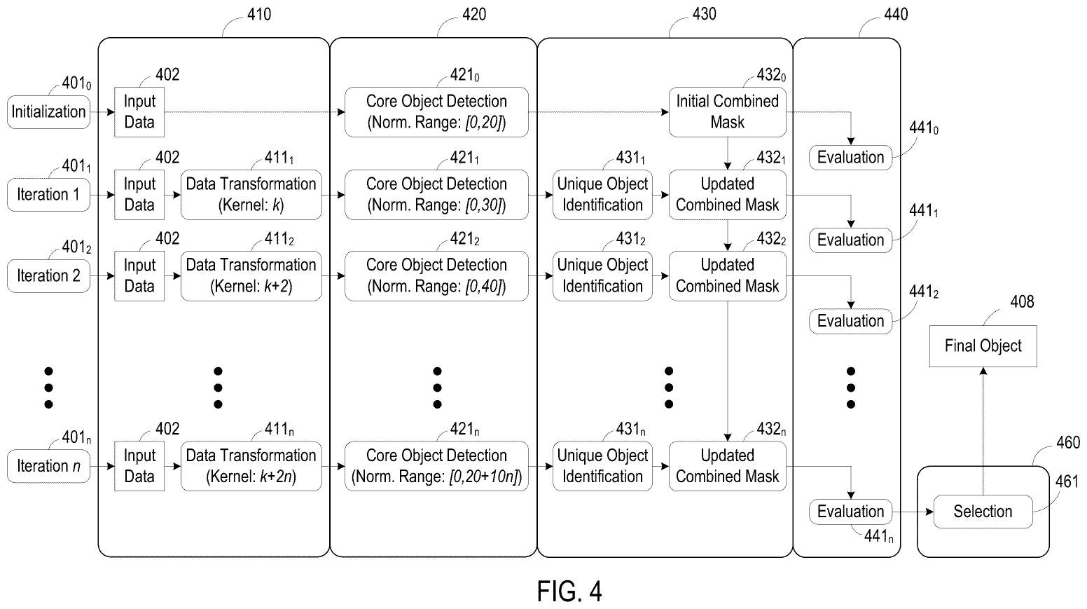

FIG. 4 illustrates an example sequence 400 of performing object detection and segmentation by iteratively processing an input data 402 (e.g., including a source image that captures an object of interest) to obtain a final object identification 408 (e.g., the object of interest). In some embodiments, sequence 400 may involve performing a series of processing iterations on an input data, including an initialization process 401₀ (e.g., an initial processing iteration) and one or more additional processing iterations 401₁-401ₙ (e.g., processing iterations 1 to n). In initialization process 401₀, a core object detection process 421₀ may be performed to generate an object mask (e.g., at object detection stage 420), which may be used to initialize a combined mask at merge 432₀ (e.g., at output aggregation stage 430). An evaluation 441₀ may be performed to determine whether processing of the input data is complete or if processing should continue (e.g., at evaluation stage 440). If a determination is made that processing should continue, iterative processing may commence. Each processing iteration may involve applying an adaptive data transformation 411₁-411ₙ to generate a transformed image (e.g., at data transformation stage 410), which may be provided as an input to a core object detection process 421₁-421ₙ (e.g., an adaptive object detection technique) to generate an object mask (e.g., at object detection stage 420). A merge 432₁-432ₙ may be performed to update the combined mask (e.g., at output aggregation stage 430), where an identification 431₁-431ₙ may be performed to identify unique elements of the object mask being processed to be merged into the combined mask. An evaluation 441₁-441ₙ may be performed at the end of each iteration (e.g., at evaluation stage 440) to determine whether processing of the input data is complete or if processing should continue. If a determination is made that processing should continue, another processing iteration is performed. If a determination is made that processing is complete (e.g., at the end of the initialization process 401₀ or any of processing iterations 401₁-401ₙ), a selection 461 may be performed (e.g., at output selection stage 460) to output a final object identification 408.

In a bit more detail, in initialization process 401₀ (or initial processing iteration), input data 402 may be processed to obtain an initial object mask, which may be used to create and initialize a combined mask. In some embodiments, input data 402 may contain a source image (or video sequence, or other multi-dimensional image), which may be made up of one or more elements in a particular arrangement (e.g., a spatial arrangement having a number of picture or volume elements in each of one or more dimensions). The source image may conform to a particular image format, which may indicate a number and type of values (and their corresponding size). In some embodiments, for example, the source image may be a 10-bit grayscale image, where each image element conveys a grayscale intensity value ranging from 0-1023.

The input data 402 may be provided as an input to an initial core object detection process 421₀, which may process a source image contained therein to obtain the initial object mask (e.g., of an initial processing iteration) that identifies elements corresponding to the object of interest. In some embodiments, for example, the core object detection process may operate to modify the elements of the transformed image to generate the object mask (e.g., by setting the value of elements representing an object to 1 (or a maximum element value) and those that do not represent an object to 0 (or a minimum element value)). The core object detection process may be defined by one or more parameters, which may vary from iteration to iteration. In some embodiments, for instance, the initial core object detection process 421₀ may be the object detection method of FIG. 3, with a desired normalization range of [0, 20] for a normalization operation performed therein.

At merge 432₀, a combined mask may be created and initialized with the initial object mask (e.g., as all elements in the initial object mask may be considered unique in an initial processing iteration).

An evaluation 441₀ may then be performed to evaluate whether termination criteria have been satisfied and determine whether processing of the input data 402 is complete or if processing should continue. In some embodiments, for example, termination criteria may specify that at least an initialization process is to be performed and a determination may be made that processing of the input data 402 should continue with one or more processing iterations.

In a first processing iteration 401₁, data transformation 411₁ may be applied to a source image (e.g., in input data 402) to generate a transformed image (e.g., of a first processing iteration). In some embodiments, initial data transformation 411₁ may modify the elements of the source image (e.g., to enhance or otherwise transform the image to facilitate detection of an object of interest captured therein) to generate the transformed image. In some embodiments, for example, initial data transformation 411₁ may involve the application of a data transformation filter (e.g., a smoothing filter) to the source image. The data transformation filter may be defined (at least in part) by a kernel size, which may vary from iteration to iteration. For instance, in initialization process 401₁, a filter having an initial kernel size of k (e.g., k elements in each dimension of the source image) may be used to generate the transformed image.

The transformed image (e.g., generated in the first processing iteration 401₁) may be provided as an input to core object detection process 421₁ to obtain an object mask therefrom. In some embodiments, core object detection process 421₁ may be similar to core object detection process 421₀ of the initialization process 4110 but with one or parameters being adjusted therebetween. In some embodiments, for instance, core object detection process 421₁ may apply the object detection method of FIG. 3 (as in core object detection process 421₀), but with a desired normalization range of [0, 30] for a normalization operation performed therein.

An identification 431₁ may be performed on the object mask that is generated to identify its unique elements. In some embodiments, for example, the object mask (e.g., of the first processing iteration 401₁) may be compared to the initial combined mask (e.g., generated in initialization process 401₀) to identify elements in the object mask that are not present in the combined mask. The unique elements may then be merged into the combined mask at merge 432₁ to obtain an updated combined mask. In some embodiments, statistical information may be collected, including for example, a number of unique elements merged into the combined mask and a size (e.g., count of elements) of the initial combined mask.

An evaluation 441₁ may then be performed to evaluate whether termination criteria have been satisfied and determine whether processing of the input data is complete or if processing should continue. In some embodiments, for example, termination criteria may specify a maximum number of processing iterations and/or a minimum amount of elements that are to be newly added in each processing iteration (e.g., 0.1% additional elements relative to a prior iteration). A determination may then be made as to the number of processing iterations that have been performed and/or an amount of elements that were newly added at merge 432₁, for example, based on the collected statistical information (e.g., as a ratio of the number of unique elements merged into the combined mask and the size of the initial combined mask). Based on a comparison with the termination criteria, a determination may be made that processing of the input data 402 should continue with a second processing iteration 401₂.

In a second processing iteration 401₂, an adapted data transformation 411₂ may be applied to the input data and an adapted core object detection process 421₂ may be performed on the transformed image generated therefrom to obtain an object mask (e.g., of the second processing iteration 401₂). In some embodiments, for instance, data transformation 411₂ may apply the data transformation filter (e.g., a smoothing filter) of data transformation 411₁ but with a kernel size of k+2, and core object detection process 421₂ may apply the object detection method of FIG. 3 (as in core object detection process 421₀ and 421₁), but with a desired normalization range of [0, 40] for a normalization operation performed therein.

An identification 431₁ may be performed on the object mask that is generated (e.g., of the second processing iteration 401₂) to identify its unique elements, which may be merged into the combined mask at merge 432₂. Statistical information may be collected at merge 432₂, including, for example, a number of unique elements merged into the combined mask and an initial size (e.g., count of elements) of the combined mask (e.g., following the first processing iteration 401₁). An evaluation 441₂ may then be performed to evaluate whether termination criteria have been satisfied and determine whether processing of the input data is complete or if processing should continue. If no termination criteria are satisfied, a determination may be made that processing of the input data should continue with another processing iteration.

The process may repeat (e.g., through an n^{th} iteration) until a determination is made at evaluation 441ₙ that termination criteria has been satisfied and processing of the input data is complete, for example, where a minimum number of processing iterations has been performed, a maximum number of processing iterations has been reached, and a satisfactory amount of object was not added in a previous iteration. A selection 461 may then be performed to output a final object identification 408 (e.g., of the object of interest captured in the source image in the input data 402). In some embodiments, for example, the combined object mask (e.g., resulting from the n^{th} processing iteration) may be processed to segment and label groups of object elements (e.g., elements having a value of 1 (or a maximum element value)) therein. In some embodiments, for example, a connected component identification technique may be employed to group spatially connected elements into one or more groups, each of which may represent a distinct object (e.g., spatially disconnected object. One or more groups of elements may be selected (e.g., based on selection criteria) for inclusion in a final object identification 408. In some embodiments, for example, a largest group of elements may be selected for inclusion in the final object identification 408.

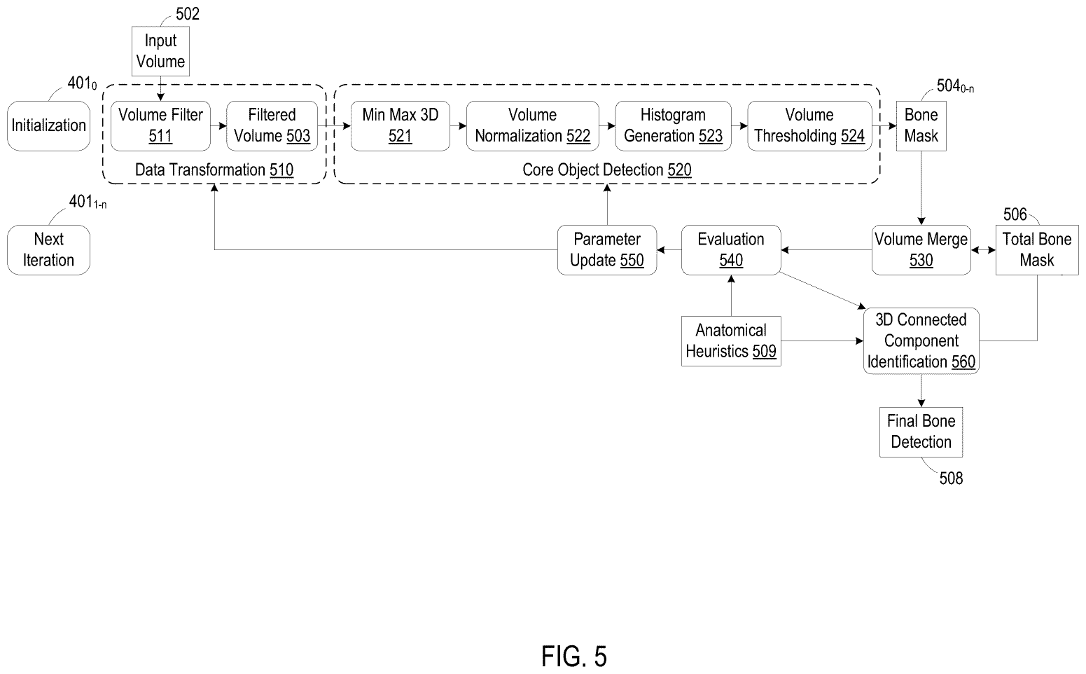

FIG. 5 illustrates a block diagram of an example object detection and segmentation process 500 for iteratively processing an image captured by a CT imaging system to identify bone structure captured therein. Object detection and segmentation process 500 may involve iteratively processing an input volume 502 (e.g., 2048×2048×2048 voxels, with each voxel having a 10-bit grayscale intensity level), for example, a 3D image captured by a CT imaging system. Object detection and segmentation process 500, for example, may involve performing an initialization process 501₀ (or an initial processing iteration) followed by zero or more additional processing iterations 510₁₋ₙ. In each processing iteration 501₀₋ₙ, data transformation 510 may be applied to the input volume 502, for example, to enhance or otherwise transform the input volume (e.g., to facilitate detection of bone captured therein). In some embodiments, for example, data transformation 510 may involve applying a volume filter 511 (e.g., a smoothing filter) to the input volume 502 to obtain a filtered volume 503. In some embodiments, for instance, a 3D Gaussian smoothing filter may be applied to the input volume 502 to obtain filtered volume 503. In some embodiments, one or more parameters of data transformation 510 may be adjusted in each processing iteration. In some embodiments, for instance, one or more parameters of volume filter 511 may be adjusted in each processing iteration, including for example, a kernel size and filter weights (e.g., by adjusting a mean and/or sigma (or σ) value of a Gaussian filter). In some embodiments, data transformation 510 may be skipped or omitted, or may involve applying an identity transformation (e.g., by applying an identity filter or using a Dirac delta function), for initialization process 501₀, with the input volume 502 serving as the transformed volume (e.g., filtered volume 503) for subsequent processing.

The transformed volume (e.g., filtered volume 503) generated by data transformation 510 (e.g., in each processing iteration 501₀₋ₙ) may be provided as an input to core object detection process 520 in which one or more data processing operations may be performed to obtain a bone mask 504₀₋ₙ, which may identify a portion of the bone structure captured in the input volume 502.

By way of example, in some embodiments, core object detection process 520 may involve determining a range of values in the transformed volume (e.g., in filtered volume 503). For instance, in some embodiments, Min Max 3D operation 521 may operate to determine a minimum and maximum intensity value across all voxels in the transformed volume.

Volume normalization operation 522 may operate to normalize the transformed volume, for example, by scaling (or otherwise adjusting) the voxel values to fall within a desired range. In some embodiments, for example, the following min-max normalization equation may be used to adjust the values of the transformed volume to fall within the range [0, r]:

$${value}^{′} = r * \frac{( value - min )}{max - min} \qquad Eq . 6$$

where value is an initial value of a voxel in transformed volume, min is a minimum value across all voxels in the transformed volume (e.g., determined by Min Max 3D operation 521), max is a maximum value across all voxels in the transformed volume (e.g., determined by Min Max 3D operation 521), r is a normalization constant (which may vary between processing iterations), and value′ is the normalized value of the voxel.

Histogram generation operation 523 may operate to generate an intensity histogram from the normalized volume. In some embodiments, for example, an intensity histogram may be generated from the normalized image by dividing the normalized range (e.g., [0, r]) into a number of bins (e.g., into a specified number of bins, or into bins of a particular width) and determining a count of voxels in the normalized volume whose value falls within each bin.

Volume thresholding operation 524 may operate to binarize the normalized volume to obtain bone mask 504₀₋ₙ, for example, by setting a voxel value to 1023 if it is above an applicable threshold value and to 0 if falls below the applicable threshold value. In some embodiments, the applicable threshold value may be determined based on an analysis of an intensity histogram of the normalized image (e.g., that was generated by histogram generation operation 523). In some embodiments, for instance, an iterative analysis may be performed in which an initial threshold value is determined (e.g., based on an identification of the histogram bin having a maximum count) and iteratively refined (e.g., until it captures a desired number and/or percentage of elements) to obtain the applicable threshold value.

Volume merge 530 may be performed to merge the bone mask 504₀₋ₙ generated in each processing iteration 501₀₋ₙ into a total bone mask 506. In some embodiments, only the unique elements of the object mask may be merged into the total bone mask 506. For instance, in an initial processing iteration (e.g., in initialization process 501₀), a total bone mask 506 may be created and initialized using bone mask 504₀ generated therein. Thereafter (e.g., in processing iterations 501₁₋ₙ), the bone mask 504₁₋ₙ may be compared to an existing total bone mask 506 to identify unique elements therein, which may then be merged into total bone mask 506. In some embodiments, a count of the unique elements identified in the bone mask 504₀₋ₙ and a count of elements in the total bone mask 506 may be collected (e.g., for use in evaluation 540).

Evaluation 540 may be performed to evaluate whether termination criteria have been satisfied and determine whether processing should proceed with a next processing iteration 501₁₋ₙ or whether processing of the input volume is complete. In some embodiments, for example, termination criteria may specify a minimum number of processing iterations (e.g., an initial processing iteration and at least 2 processing iterations thereafter), a maximum number of processing iterations (e.g., a maximum of 12 processing iterations), and a minimum amount of elements to be newly added in each processing iteration (e.g., 0.1% additional elements relative to a prior iteration). In some embodiments, termination criteria may be determined based upon different anatomical heuristics 509. For instance, in some embodiments, anatomical heuristics 509 may indicate the amount of newly added elements that are to be expected in a particular processing iteration (e.g., based on application of a particular data transformation 510).

If a determination is made that a next iteration is to be performed, one or more parameters (e.g., of data transformation 510 and/or core object detection process 520) may be updated by parameter update 550 and a next iteration (e.g., of data transformation 510, core object detection process 520, volume merge 530, and evaluation 540) may be performed.

Alternatively, if a determination is made that processing is complete, a selection may be made to obtain a final bone identification 508. In some embodiments, for example, a 3D connected component identification operation 560 may be performed to group spatially connected voxels in the total bone mask 506 into one or more groups, each of which may represent distinct, spatially disconnected bone structure. One or more groups of voxels may be selected (e.g., based on selection criteria) for inclusion in a final bone identification 508. In some embodiments, the selection may be made based upon different anatomical heuristics 509. In some embodiments, for example, a largest group of voxels (e.g., which may correspond to a largest detected bone structure) may be selected for inclusion in the final bone identification 508.

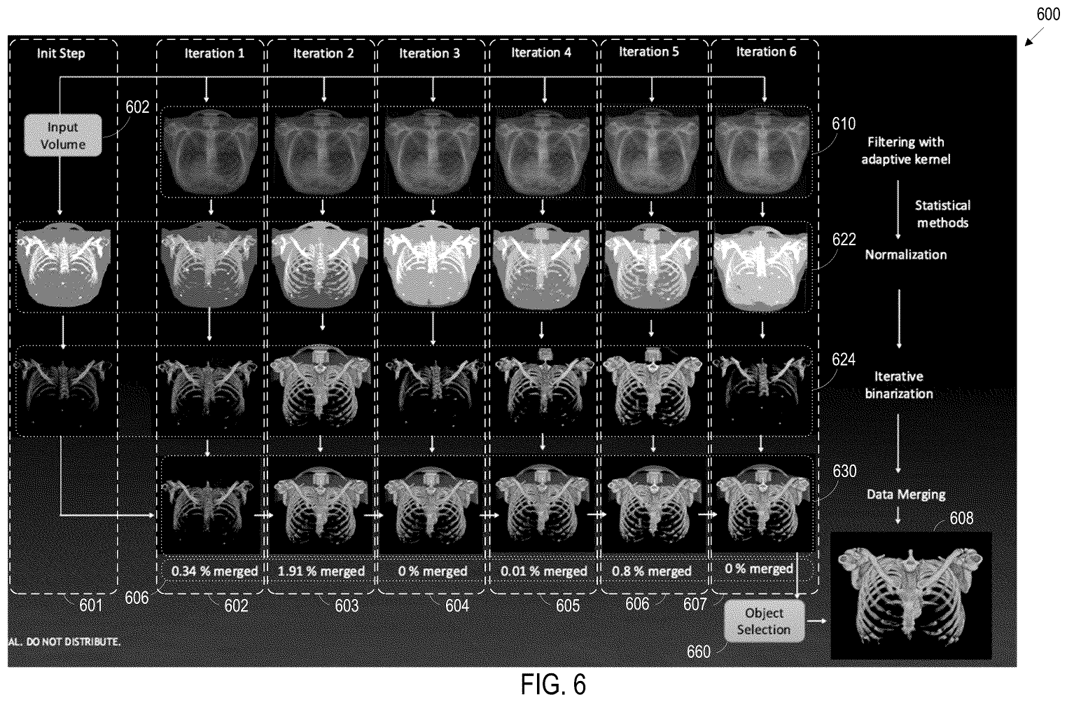

FIG. 6 illustrates example results 600 of an iterative object detection and segmentation process performed on an image captured by a CT imaging system to identify bone structure captured therein. The object detection and segmentation process may iteratively process an input volume 602, for example, a 3D image captured by a CT imaging system, and may involve an initialization process 601 followed by a number of additional processing iterations (e.g., processing iterations 602-607). In initialization process 601, input volume 602 may be provided as an input to a core object detection process that may involve normalizing the input volume to generate a normalized volume (illustrated as intermediate result 622) and binarizing the normalized volume to generate an object mask (illustrated as result 624). In some embodiments, binarization may be performed through thresholding where an applicable thresholding value is determined through an iterative analysis of a intensity histogram of the normalized image. The object mask (illustrated as result 624) generated in the initialization process 601 may be used to initialize a combined mask (not illustrated).

In processing iterations 602-607, a data transformation (e.g., a smoothing filter) may be applied to the input volume 602 to generate a transformed volume (e.g., a filtered volume) (illustrated as intermediate result 610). One or more parameters of the data transformation (e.g., a kernel size and/or kernel weights) may be varied between each processing iteration to enhance or transform the input volume in different ways, which may allow for a unique portion of an object to be detected therein. The transformed image (illustrated as intermediate result 610) may be provided as an input to a core object detection process that may involve normalizing the input volume to generate a normalized volume (illustrated as intermediate result 622) and binarizing the normalized volume to generate an object mask (illustrated as result 624). The unique elements of each object mask may be identified and merged into a combined mask (e.g., resulting from a previous iteration or the initialization process) (illustrated as result 630). Statistical information (e.g., the percentage of voxels newly added to the combined mask) may be collected when merging the object mask into the combined mask).

Upon completion of a last processing iteration (e.g., processing iteration 607), a selection may be performed to output a final object identification (illustrated as result 608). In some embodiments, selection may involve processing the combined mask (e.g., resulting from processing iteration 607) to segment and label groups of object elements therein, and select one or more groups of elements (e.g., based on selection criteria) for inclusion in a final object identification 608.

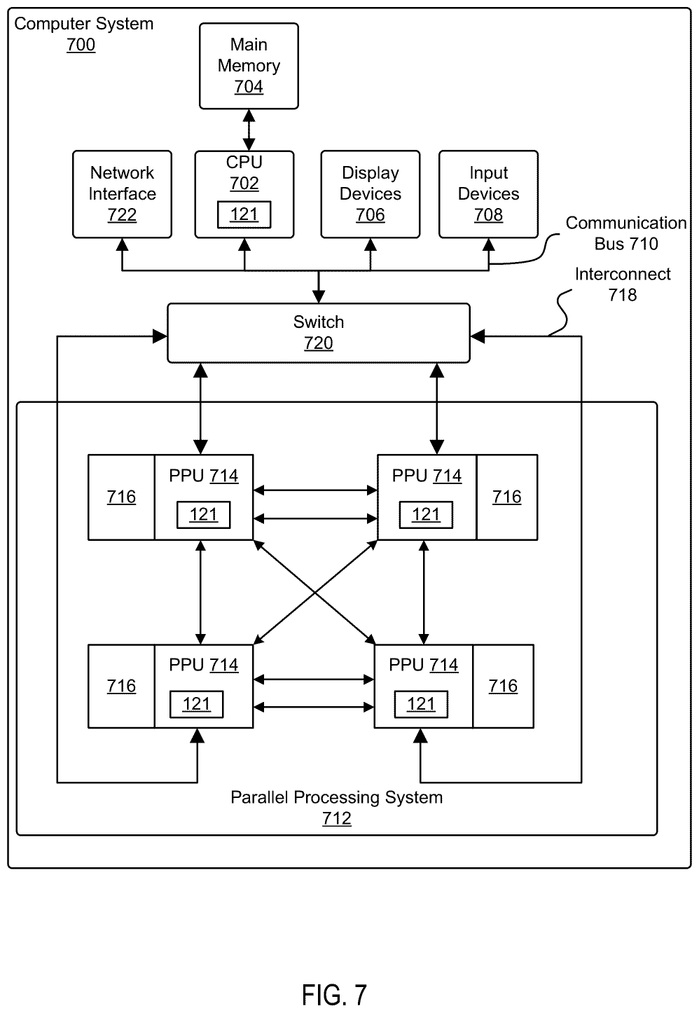

FIG. 7 illustrates a computer system 700, according to at least one embodiment. In at least one embodiment, computer system 700 is configured to implement various processes and methods described throughout this disclosure.

In at least one embodiment, computer system 700 comprises at least one central processing unit (“CPU”) 702 that is connected to a communication bus 710 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 700 includes a main memory 704, which may take form of random access memory (“RAM”). Control logic (e.g., implemented as hardware, software, or a combination thereof) and data are stored in main memory 704. In at least one embodiment, a network interface subsystem (“network interface”) 722 provides an interface to other computing devices and networks for receiving data from and transmitting data to other systems with computer system 700.

In at least one embodiment, computer system 700 includes one or more input devices 708, a parallel processing system 712, and one or more display devices 706 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 708 such as keyboard, mouse, touchpad, microphone, etc. In at least one embodiment, each module described herein can be situated on a single semiconductor platform to form a processing system.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the system 700 of FIG. 7 for performing image processing operations, including object detection and segmentation operations.

In at least one embodiment, computer programs in form of machine-readable executable code or computer control logic algorithms are stored in main memory 704 and/or secondary storage. Computer programs, if executed by one or more processors, enable system 700 to perform various functions in accordance with at least one embodiment. In at least one embodiment, memory 704, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc.

In at least one embodiment, architecture and/or functionality of various previous figures are implemented in the context of CPU 702, parallel processing system 712, an integrated circuit capable of at least a portion of capabilities of both CPU 702 and parallel processing system 712, a chipset (e.g., a group of integrated circuits designed to work and sold as a unit for performing related functions, etc.), and/or any suitable combination of integrated circuit(s). In at least one embodiment, architecture and/or functionality of various previous figures are implemented in the context of a general computer system, a circuit board system, a game console system dedicated for entertainment purposes, an application-specific system, and more. In at least one embodiment, computer system 700 may take the form of a desktop computer, a laptop computer, a tablet computer, a server, a supercomputer, a smart-phone (e.g., a wireless, hand-held device), a personal digital assistant (“PDA”), a digital camera, a vehicle, a head mounted display, a hand-held electronic device, a mobile phone device, a television, a workstation, a game console, an embedded system, and/or any other type of logic device.

In at least one embodiment, parallel processing system 712 includes a plurality of parallel processing units (“PPUs”) 714 and associated memories 716. In at least one embodiment, PPUs 714 are connected to a host processor or other peripheral devices via an interconnect 718 and a switch 720 or multiplexer. In at least one embodiment, parallel processing system 712 distributes computational tasks across PPUs 714 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 714, although such shared memory may incur performance penalties relative to use of local memory and registers resident to a PPU 714. In at least one embodiment, operation of PPUs 714 is synchronized through use of a command such as _syncthreads( ), wherein all threads in a block (e.g., executed across multiple PPUs 714) to reach a certain point of execution of code before proceeding.

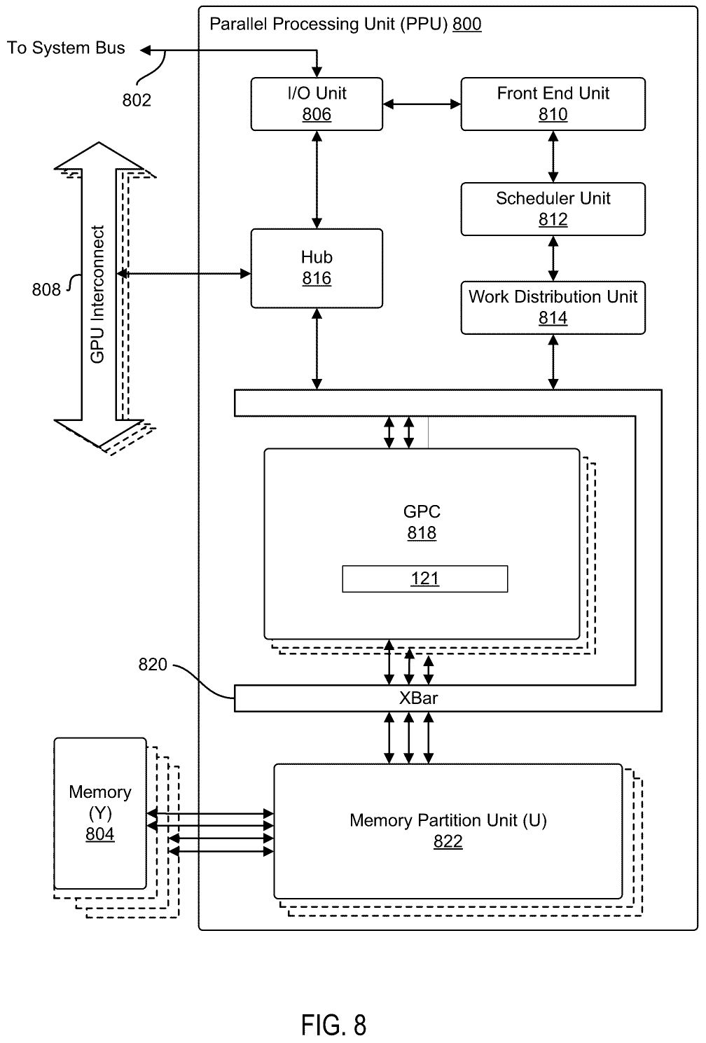

FIG. 8 illustrates a parallel processing unit (“PPU”) 800, according to at least one embodiment. In at least one embodiment, PPU 800 is configured with machine-readable code that, if executed by PPU 800, causes PPU 800 to perform some or all of processes and techniques described throughout this disclosure. In at least one embodiment, PPU 800 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, a thread refers to a thread of execution and is an instantiation of a set of instructions configured to be executed by PPU 800. In at least one embodiment, PPU 800 is a graphics processing unit (“GPU”) configured to implement a graphics rendering pipeline for processing three-dimensional (“3D”) graphics data in order to generate two-dimensional (“2D”) image data for display on a display device such as a liquid crystal display (“LCD”) device. In at least one embodiment, PPU 800 is utilized to perform computations such as linear algebra operations and machine-learning operations. FIG. 8 illustrates an example parallel processor for illustrative purposes only and should be construed as a non-limiting example of processor architectures contemplated within scope of this disclosure and that any suitable processor may be employed to supplement and/or substitute for same.

In at least one embodiment, one or more PPUs 800 are configured to accelerate High Performance Computing (“HPC”), data center, and machine learning applications. In at least one embodiment, PPU 800 is configured to accelerate deep learning systems and applications including following non-limiting examples: autonomous vehicle platforms, deep learning, high-accuracy speech, image, text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and more.

In at least one embodiment, PPU 800 includes an Input/Output (“I/O”) unit 806, a front-end unit 810, a scheduler unit 812, a work distribution unit 814, a hub 816, a crossbar (“XBar”) 820, one or more general processing clusters (“GPCs”) 818, and one or more partition units (“memory partition units”) 822. In at least one embodiment, PPU 800 is connected to a host processor or other PPUs 800 via one or more high-speed GPU interconnects (“GPU interconnects”) 808. In at least one embodiment, PPU 800 is connected to a host processor or other peripheral devices via a system bus 802. In at least one embodiment, PPU 800 is connected to a local memory comprising one or more memory devices (“memory”) 804. In at least one embodiment, memory devices 804 include one or more dynamic random access memory (“DRAM”) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 808 may refer to a wire-based multi-lane communications link that is used by systems to scale and include one or more PPUs 800 combined with one or more central processing units (“CPUs”), supports cache coherence between PPUs 800 and CPUs, and CPU mastering. In at least one embodiment, data and/or commands are transmitted by high-speed GPU interconnect 808 through hub 816 to/from other units of PPU 800 such as one or more copy engines, video encoders, video decoders, power management units, and other components which may not be explicitly illustrated in FIG. 8.

In at least one embodiment, I/O unit 806 is configured to transmit and receive communications (e.g., commands, data) from a host processor (not illustrated in FIG. 8) over system bus 802. In at least one embodiment, I/O unit 806 communicates with host processor directly via system bus 802 or through one or more intermediate devices such as a memory bridge. In at least one embodiment, I/O unit 806 may communicate with one or more other processors, such as one or more of PPUs 800 via system bus 802. In at least one embodiment, I/O unit 806 implements a Peripheral Component Interconnect Express (“PCIe”) interface for communications over a PCIe bus. In at least one embodiment, I/O unit 806 implements interfaces for communicating with external devices.

In at least one embodiment, I/O unit 806 decodes packets received via system bus 802. In at least one embodiment, at least some packets represent commands configured to cause PPU 800 to perform various operations. In at least one embodiment, I/O unit 806 transmits decoded commands to various other units of PPU 800 as specified by commands. In at least one embodiment, commands are transmitted to front-end unit 810 and/or transmitted to hub 816 or other units of PPU 800 such as one or more copy engines, a video encoder, a video decoder, a power management unit, etc. (not explicitly illustrated in FIG. 8). In at least one embodiment, I/O unit 806 is configured to route communications between and among various logical units of PPU 800.

In at least one embodiment, a program executed by host processor encodes a command stream in a buffer that provides workloads to PPU 800 for processing. In at least one embodiment, a workload comprises instructions and data to be processed by those instructions. In at least one embodiment, a buffer is a region in a memory that is accessible (e.g., read/write) by both a host processor and PPU 800—a host interface unit may be configured to access that buffer in a system memory connected to system bus 802 via memory requests transmitted over system bus 802 by I/O unit 806. In at least one embodiment, a host processor writes a command stream to a buffer and then transmits a pointer to a start of a command stream to PPU 800 such that front-end unit 810 receives pointers to one or more command streams and manages one or more command streams, reading commands from command streams and forwarding commands to various units of PPU 800.

In at least one embodiment, front-end unit 810 is coupled to scheduler unit 812 that configures various GPCs 818 to process tasks defined by one or more command streams. In at least one embodiment, scheduler unit 812 is configured to track state information related to various tasks managed by scheduler unit 812 where state information may indicate which of GPCs 818 a task is assigned to, whether task is active or inactive, a priority level associated with task, and so forth. In at least one embodiment, scheduler unit 812 manages execution of a plurality of tasks on one or more of GPCs 818.

In at least one embodiment, scheduler unit 812 is coupled to work distribution unit 814 that is configured to dispatch tasks for execution on GPCs 818. In at least one embodiment, work distribution unit 814 tracks a number of scheduled tasks received from scheduler unit 812 and work distribution unit 814 manages a pending task pool and an active task pool for each of GPCs 818. In at least one embodiment, pending task pool comprises a number of slots (e.g., 32 slots) that contain tasks assigned to be processed by a particular GPC 818; an active task pool may comprise a number of slots (e.g., 4 slots) for tasks that are actively being processed by GPCs 818 such that as one of GPCs 818 completes execution of a task, that task is evicted from that active task pool for GPC 818 and another task from a pending task pool is selected and scheduled for execution on GPC 818. In at least one embodiment, if an active task is idle on GPC 818, such as while waiting for a data dependency to be resolved, then that active task is evicted from GPC 818 and returned to that pending task pool while another task in that pending task pool is selected and scheduled for execution on GPC 818.

In at least one embodiment, work distribution unit 814 communicates with one or more GPCs 818 via XBar 820. In at least one embodiment, XBar 820 is an interconnect network that couples many of units of PPU 800 to other units of PPU 800 and can be configured to couple work distribution unit 814 to a particular GPC 818. In at least one embodiment, one or more other units of PPU 800 may also be connected to XBar 820 via hub 816.

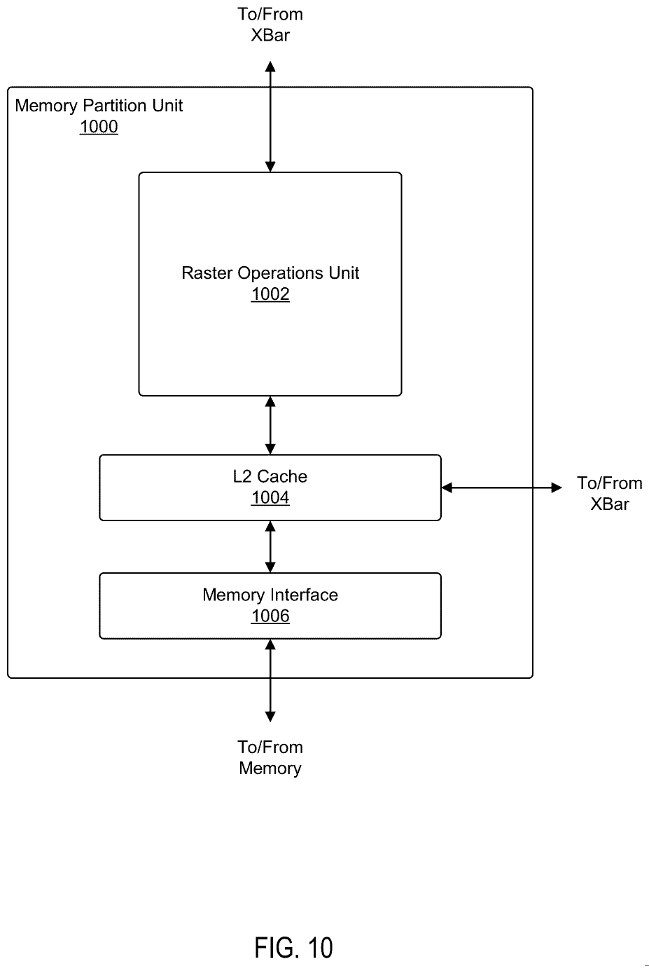

In at least one embodiment, tasks are managed by scheduler unit 812 and dispatched to one of GPCs 818 by work distribution unit 814. In at least one embodiment, GPC 818 is configured to process task and generate results. In at least one embodiment, results may be consumed by other tasks within GPC 818, routed to a different GPC 818 via XBar 820, or stored in memory 804. In at least one embodiment, results can be written to memory 804 via partition units 822, which implement a memory interface for reading and writing data to/from memory 804. In at least one embodiment, results can be transmitted to another PPU 804 or CPU via high-speed GPU interconnect 808. In at least one embodiment, PPU 800 includes a number U of partition units 822 that is equal to a number of separate and distinct memory devices 804 coupled to PPU 800, as described in more detail herein in conjunction with FIG. 10.

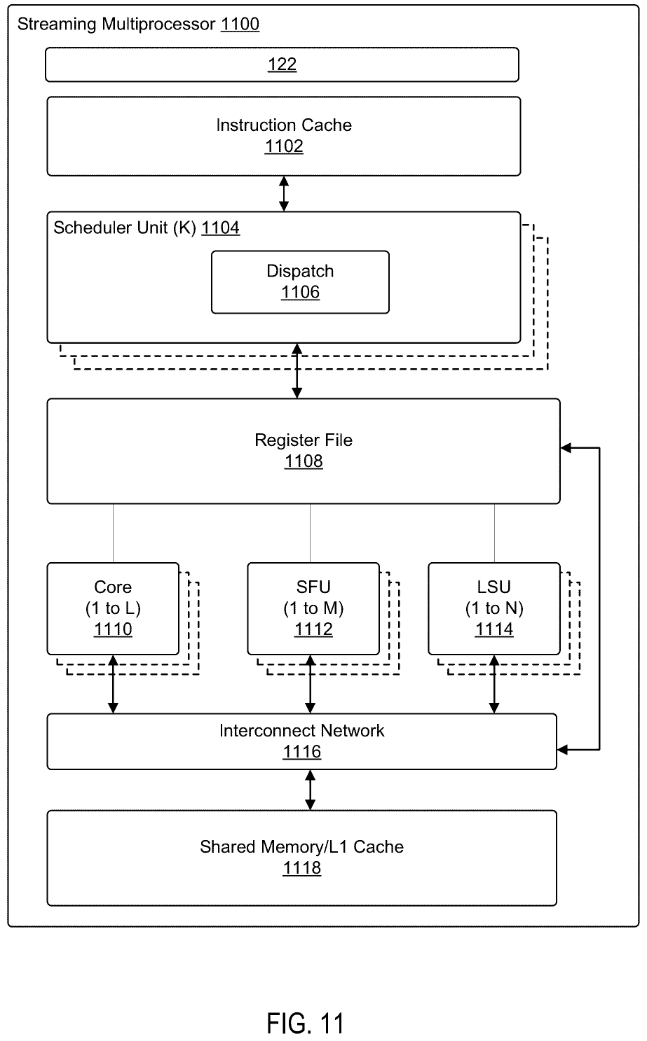

In at least one embodiment, a host processor executes a driver kernel that implements an application programming interface (“API”) that enables one or more applications executing on a host processor to schedule operations for execution on PPU 800. In at least one embodiment, multiple compute applications are simultaneously executed by PPU 800 and PPU 800 provides isolation, quality of service (“QoS”), and independent address spaces for multiple compute applications. In at least one embodiment, an application generates instructions (e.g., in form of API calls) that cause a driver kernel to generate one or more tasks for execution by PPU 800 and that driver kernel outputs tasks to one or more streams being processed by PPU 800. In at least one embodiment, each task comprises one or more groups of related threads, which may be referred to as a warp. In at least one embodiment, a warp comprises a plurality of related threads (e.g., 32 threads) that can be executed in parallel. In at least one embodiment, cooperating threads can refer to a plurality of threads including instructions to perform task and that exchange data through shared memory. In at least one embodiment, threads and cooperating threads are described in more detail in conjunction with FIG. 11.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the PPU 800 of FIG. 8 for performing image processing operations, including object detection and segmentation operations.

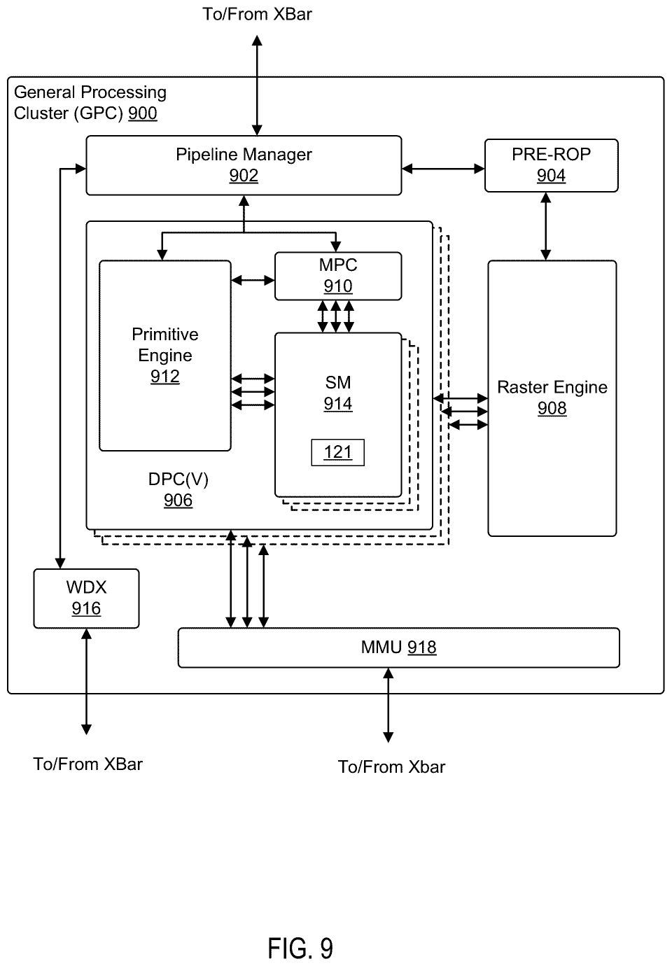

FIG. 9 illustrates a general processing cluster (“GPC”) 900, according to at least one embodiment. In at least one embodiment, GPC 900 is GPC 818 of FIG. 8. In at least one embodiment, each GPC 900 includes a number of hardware units for processing tasks and each GPC 900 includes a pipeline manager 902, a pre-raster operations unit (“preROP”) 904, a raster engine 908, a work distribution crossbar (“WDX”) 916, a memory management unit (“MMU”) 918, one or more Data Processing Clusters (“DPCs”) 906, and any suitable combination of parts.

In at least one embodiment, operation of GPC 900 is controlled by pipeline manager 902. In at least one embodiment, pipeline manager 902 manages configuration of one or more DPCs 906 for processing tasks allocated to GPC 900. In at least one embodiment, pipeline manager 902 configures at least one of one or more DPCs 906 to implement at least a portion of a graphics rendering pipeline. In at least one embodiment, DPC 906 is configured to execute a vertex shader program on a programmable streaming multi-processor (“SM”) 914. In at least one embodiment, pipeline manager 902 is configured to route packets received from a work distribution unit to appropriate logical units within GPC 900, in at least one embodiment, and some packets may be routed to fixed function hardware units in preROP 904 and/or raster engine 908 while other packets may be routed to DPCs 906 for processing by a primitive engine 912 or SM 914. In at least one embodiment, pipeline manager 902 configures at least one of DPCs 906 to implement a neural network model and/or a computing pipeline.

In at least one embodiment, preROP unit 904 is configured, in at least one embodiment, to route data generated by raster engine 908 and DPCs 906 to a Raster Operations (“ROP”) unit in partition unit 822, described in more detail above in conjunction with FIG. 8. In at least one embodiment, preROP unit 904 is configured to perform optimizations for color blending, organize pixel data, perform address translations, and more. In at least one embodiment, raster engine 908 includes a number of fixed function hardware units configured to perform various raster operations, in at least one embodiment, and raster engine 908 includes a setup engine, a coarse raster engine, a culling engine, a clipping engine, a fine raster engine, a tile coalescing engine, and any suitable combination thereof. In at least one embodiment, setup engine receives transformed vertices and generates plane equations associated with geometric primitive defined by vertices; plane equations are transmitted to a coarse raster engine to generate coverage information (e.g., an x, y coverage mask for a tile) for primitive; output of a coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, an output of raster engine 908 comprises fragments to be processed by any suitable entity, such as by a fragment shader implemented within DPC 906.

In at least one embodiment, each DPC 906 included in GPC 900 comprises an M-Pipe Controller (“MPC”) 910; primitive engine 912; one or more SMs 914; and any suitable combination thereof. In at least one embodiment, MPC 910 controls operation of DPC 906, routing packets received from pipeline manager 902 to appropriate units in DPC 906. In at least one embodiment, packets associated with a vertex are routed to primitive engine 912, which is configured to fetch vertex attributes associated with a vertex from memory; in contrast, packets associated with a shader program may be transmitted to SM 914.

In at least one embodiment, SM 914 comprises a programmable streaming processor that is configured to process tasks represented by a number of threads. In at least one embodiment, SM 914 is multi-threaded and configured to execute a plurality of threads (e.g., 32 threads) from a particular group of threads concurrently and implements a Single-Instruction, Multiple-Data (“SIMD”) architecture where each thread in a group of threads (e.g., a warp) is configured to process a different set of data based on same set of instructions. In at least one embodiment, all threads in group of threads execute a common set of instructions. In at least one embodiment, SM 914 implements a Single-Instruction, Multiple Thread (“SIMT”) architecture wherein each thread in a group of threads is configured to process a different set of data based on that common set of instructions, but where individual threads in a group of threads are allowed to diverge during execution. In at least one embodiment, a program counter, call stack, and execution state is maintained for each warp, enabling concurrency between warps and serial execution within warps when threads within a warp diverge. In another embodiment, a program counter, call stack, and execution state is maintained for each individual thread, enabling equal concurrency between all threads, within and between warps. In at least one embodiment, execution state is maintained for each individual thread and threads executing common instructions may be converged and executed in parallel for better efficiency. At least one embodiment of SM 914 is described in more detail herein.

In at least one embodiment, MMU 918 provides an interface between GPC 900 and a memory partition unit (e.g., partition unit 822 of FIG. 8) and MMU 918 provides translation of virtual addresses into physical addresses, memory protection, and arbitration of memory requests. In at least one embodiment, MMU 918 provides one or more translation lookaside buffers (“TLBs”) for performing translation of virtual addresses into physical addresses in memory.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the GPC 900 of FIG. 9 for performing image processing operations, including object detection and segmentation operations.

FIG. 10 illustrates a memory partition unit 1000 of a parallel processing unit (“PPU”), in accordance with at least one embodiment. In at least one embodiment, memory partition unit 1000 includes a Raster Operations (“ROP”) unit 1002, a level two (“L2”) cache 1004, a memory interface 1006, and any suitable combination thereof. In at least one embodiment, memory interface 1006 is coupled to memory. In at least one embodiment, memory interface 1006 may implement 32, 64, 128, 1024-bit data buses, or like, for high-speed data transfer. In at least one embodiment, PPU incorporates U memory interfaces 1006 where U is a positive integer, with one memory interface 1006 per pair of partition units 1000, where each pair of partition units 1000 is connected to a corresponding memory device. For example, in at least one embodiment, PPU may be connected to up to Y memory devices, such as high bandwidth memory stacks or graphics double-data-rate, version 5, synchronous dynamic random access memory (“GDDR5 SDRAM”).

In at least one embodiment, memory interface 1006 implements a high bandwidth memory second generation (“HBM2”) memory interface and Y equals half of U. In at least one embodiment, HBM2 memory stacks are located on a physical package with a PPU, providing substantial power and area savings compared with conventional GDDR5 SDRAM systems. In at least one embodiment, each HBM2 stack includes four memory dies with Y=4, with each HBM2 stack including two 122-bit channels per die for a total of 8 channels and a data bus width of 1024 bits. In at least one embodiment, that memory supports Single-Error Correcting Double-Error Detecting (“SECDED”) Error Correction Code (“ECC”) to protect data. In at least one embodiment, ECC can provide higher reliability for compute applications that are sensitive to data corruption.

In at least one embodiment, PPU implements a multi-level memory hierarchy. In at least one embodiment, memory partition unit 1000 supports a unified memory to provide a single unified virtual address space for central processing unit (“CPU”) and PPU memory, enabling data sharing between virtual memory systems. In at least one embodiment frequency of accesses by a PPU to a memory located on other processors is traced to ensure that memory pages are moved to physical memory of PPU that is accessing pages more frequently. In at least one embodiment, high-speed GPU interconnect 808 supports address translation services allowing PPU to directly access a CPU's page tables and providing full access to CPU memory by a PPU.

In at least one embodiment, copy engines transfer data between multiple PPUs or between PPUs and CPUs. In at least one embodiment, copy engines can generate page faults for addresses that are not mapped into page tables and memory partition unit 1000 then services page faults, mapping addresses into page table, after which copy engine performs a transfer. In at least one embodiment, memory is pinned (e.g., non-pageable) for multiple copy engine operations between multiple processors, substantially reducing available memory. In at least one embodiment, with hardware page faulting, addresses can be passed to copy engines without regard as to whether memory pages are resident, and a copy process is transparent.

Data from memory 704 of FIG. 7 or other system memory is fetched by memory partition unit 1000 and stored in L2 cache 1004, which is located on-chip and is shared between various GPCs, in accordance with at least one embodiment. Each memory partition unit 1000, in at least one embodiment, includes at least a portion of L2 cache associated with a corresponding memory device. In at least one embodiment, lower level caches are implemented in various units within GPCs. In at least one embodiment, each of SMs 914 in FIG. 9 may implement a Level 1 (“L1”) cache wherein that L1 cache is private memory that is dedicated to a particular SM 914 and data from L2 cache 1004 is fetched and stored in each L1 cache for processing in functional units of SMs 914. In at least one embodiment, L2 cache 1004 is coupled to memory interface 1006 and XBar 820 shown in FIG. 8.

ROP unit 1002 performs graphics raster operations related to pixel color, such as color compression, pixel blending, and more, in at least one embodiment. ROP unit 1002, in at least one embodiment, implements depth testing in conjunction with raster engine 508, receiving a depth for a sample location associated with a pixel fragment from a culling engine of raster engine 508. In at least one embodiment, depth is tested against a corresponding depth in a depth buffer for a sample location associated with a fragment. In at least one embodiment, if that fragment passes that depth test for that sample location, then ROP unit 1002 updates depth buffer and transmits a result of that depth test to raster engine 908. It will be appreciated that a number of partition units 1000 may be different than a number of GPCs and, therefore, each ROP unit 1002 can, in at least one embodiment, be coupled to each GPC. In at least one embodiment, ROP unit 1002 tracks packets received from different GPCs and determines whether a result generated by ROP unit 1002 is to be routed to through XBar 820.

FIG. 11 illustrates a streaming multi-processor (“SM”) 1100, according to at least one embodiment. In at least one embodiment, SM 1100 is SM 914 of FIG. 9. In at least one embodiment, SM 1100 includes an instruction cache 1102, one or more scheduler units 1104, a register 1108, one or more processing cores (“cores”) 1110, one or more special function units (“SFUs”) 1112, one or more load/store units (“LSUs”) 1114, an interconnect network 1116, a shared memory/level one (“L1”) cache 1118, and/or any suitable combination thereof.

In at least one embodiment, a work distribution unit dispatches tasks for execution on general processing clusters (“GPCs”) of parallel processing units (“PPUs”) and each task is allocated to a particular Data Processing Cluster (“DPC”) within a GPC and, if a task is associated with a shader program, that task is allocated to one of SMs 1100. In at least one embodiment, scheduler unit 1104 receives tasks from a work distribution unit and manages instruction scheduling for one or more thread blocks assigned to SM 1100. In at least one embodiment, scheduler unit 1104 schedules thread blocks for execution as warps of parallel threads, wherein each thread block is allocated at least one warp. In at least one embodiment, each warp executes threads. In at least one embodiment, scheduler unit 1104 manages a plurality of different thread blocks, allocating warps to different thread blocks and then dispatching instructions from plurality of different cooperative groups to various functional units (e.g., processing cores 1110, SFUs 1112, and LSUs 1114) during each clock cycle.

In at least one embodiment, Cooperative Groups may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, applications of conventional programming models provide a single, simple construct for synchronizing cooperating threads: a barrier across all threads of a thread block (e.g., syncthreads( ) function). However, in at least one embodiment, programmers may define groups of threads at smaller than thread block granularities and synchronize within defined groups to enable greater performance, design flexibility, and software reuse in form of collective group-wide function interfaces. In at least one embodiment, Cooperative Groups enables programmers to define groups of threads explicitly at sub-block (e.g., as small as a single thread) and multi-block granularities, and to perform collective operations such as synchronization on threads in a cooperative group. In at least one embodiment, that programming model supports clean composition across software boundaries, so that libraries and utility functions can synchronize safely within their local context without having to make assumptions about convergence. In at least one embodiment, Cooperative Groups primitives enable new patterns of cooperative parallelism, including producer-consumer parallelism, opportunistic parallelism, and global synchronization across an entire grid of thread blocks.

In at least one embodiment, a dispatch unit 1106 is configured to transmit instructions to one or more functional units and scheduler unit 1104 and includes two dispatch units 1106 that enable two different instructions from a common warp to be dispatched during each clock cycle. In at least one embodiment, each scheduler unit 1104 includes a single dispatch unit 1106 or additional dispatch units 1106.

In at least one embodiment, each SM 1100, in at least one embodiment, includes register 1108 that provides a set of registers for functional units of SM 1100. In at least one embodiment, register 1108 is divided between each functional unit such that each functional unit is allocated a dedicated portion of register 1108. In at least one embodiment, register 1108 is divided between different warps being executed by SM 1100 and register 1108 provides temporary storage for operands connected to data paths of functional units. In at least one embodiment, each SM 1100 comprises a plurality of L processing cores 1110, where L is a positive integer. In at least one embodiment, SM 1100 includes a large number (e.g., 122 or more) of distinct processing cores 1110. In at least one embodiment, each processing core 1110 includes a fully-pipelined, single-precision, double-precision, and/or mixed precision processing unit that includes a floating point arithmetic logic unit and an integer arithmetic logic unit. In at least one embodiment, floating point arithmetic logic units implement IEEE 754-2008 standard for floating point arithmetic. In at least one embodiment, processing cores 1110 include 64 single-precision (32-bit) floating point cores, 64 integer cores, 32 double-precision (64-bit) floating point cores, and 8 tensor cores.

Tensor cores are configured to perform matrix operations in accordance with at least one embodiment. In at least one embodiment, one or more tensor cores are included in processing cores 1110. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation, D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA 9 C++ API, exposes specialized matrix load, matrix multiply and accumulate, and matrix store operations to efficiently use tensor cores from a CUDA-C++ program. In at least one embodiment, at a CUDA level, a warp-level interface assumes 16×16 size matrices spanning all 32 threads of warp.

In at least one embodiment, each SM 1100 comprises M SFUs 1112 that perform special functions (e.g., attribute evaluation, reciprocal square root, and like). In at least one embodiment, SFUs 1112 include a tree traversal unit configured to traverse a hierarchical tree data structure. In at least one embodiment, SFUs 1112 include a texture unit configured to perform texture map filtering operations. In at least one embodiment, texture units are configured to load texture maps (e.g., a 2D array of texels) from memory and sample texture maps to produce sampled texture values for use in shader programs executed by SM 1100. In at least one embodiment, texture maps are stored in shared memory/L1 cache 1118. In at least one embodiment, texture units implement texture operations such as filtering operations using mip-maps (e.g., texture maps of varying levels of detail), in accordance with at least one embodiment. In at least one embodiment, each SM 1100 includes two texture units.

Each SM 1100 comprises N LSUs 1114 that implement load and store operations between shared memory/L1 cache 1118 and register 1108, in at least one embodiment. Interconnect network 1116 connects each functional unit to register 1108 and LSU 1114 to register 1108 and shared memory/L1 cache 1118 in at least one embodiment. In at least one embodiment, interconnect network 1116 is a crossbar that can be configured to connect any functional units to any registers in register 1108 and connect LSUs 1114 to register 1108 and memory locations in shared memory/L1 cache 1118.

In at least one embodiment, shared memory/L1 cache 1118 is an array of on-chip memory that allows for data storage and communication between SM 1100 and primitive engine and between threads in SM 1100, in at least one embodiment. In at least one embodiment, shared memory/L1 cache 1118 comprises 122 KB of storage capacity and is in a path from SM 1100 to a partition unit. In at least one embodiment, shared memory/L1 cache 1118, in at least one embodiment, is used to cache reads and writes. In at least one embodiment, one or more of shared memory/L1 cache 1118, L2 cache, and memory are backing stores.

Combining data cache and shared memory functionality into a single memory block provides improved performance for both types of memory accesses, in at least one embodiment. In at least one embodiment, capacity is used or is usable as a cache by programs that do not use shared memory, such as if shared memory is configured to use half of a capacity, and texture and load/store operations can use remaining capacity. Integration within shared memory/L1 cache 1118 enables shared memory/L1 cache 1118 to function as a high-throughput conduit for streaming data while simultaneously providing high-bandwidth and low-latency access to frequently reused data, in accordance with at least one embodiment. In at least one embodiment, when configured for general purpose parallel computation, a simpler configuration can be used compared with graphics processing. In at least one embodiment, fixed function graphics processing units are bypassed, creating a much simpler programming model. In a general purpose parallel computation configuration, a work distribution unit assigns and distributes blocks of threads directly to DPCs, in at least one embodiment. In at least one embodiment, threads in a block execute a common program, using a unique thread ID in calculation to ensure each thread generates unique results, using SM 1100 to execute program and perform calculations, shared memory/L1 cache 1118 to communicate between threads, and LSU 1114 to read and write global memory through shared memory/L1 cache 1118 and memory partition unit. In at least one embodiment, when configured for general purpose parallel computation, SM 1100 writes commands that scheduler unit 1104 can use to launch new work on DPCs.

In at least one embodiment, a PPU is included in or coupled to a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, and more. In at least one embodiment, a PPU is embodied on a single semiconductor substrate. In at least one embodiment, a PPU is included in a system-on-a-chip (“SoC”) along with one or more other devices such as additional PPUs, memory, a reduced instruction set computer (“RISC”) CPU, a memory management unit (“MMU”), a digital-to-analog converter (“DAC”), and like.

In at least one embodiment, a PPU may be included on a graphics card that includes one or more memory devices. In at least one embodiment, that graphics card may be configured to interface with a PCIe slot on a motherboard of a desktop computer. In at least one embodiment, that PPU may be an integrated graphics processing unit (“iGPU”) included in chipset of a motherboard.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the SM 1100 of FIG. 11 for performing image processing operations, including object detection and segmentation operations.

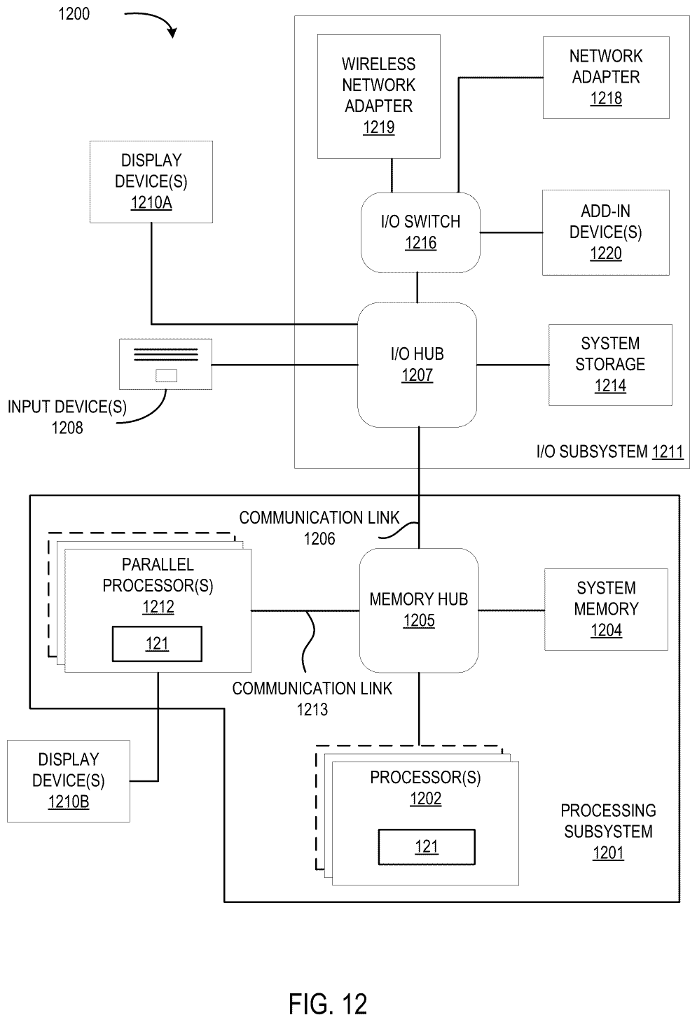

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as, but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O Hub 1207. In at least one embodiment, parallel processor(s) 1212 can also include a display controller and display interface (not shown) to enable a direct connection to one or more display device(s) 1210B.

In at least one embodiment, a system storage unit 1214 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU). In at least one embodiment, parallel processor(s) 1212 incorporate circuitry optimized for general purpose processing. In at least one embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the computing system 1200 of FIG. 12 for performing image processing operations, including object detection and segmentation operations.

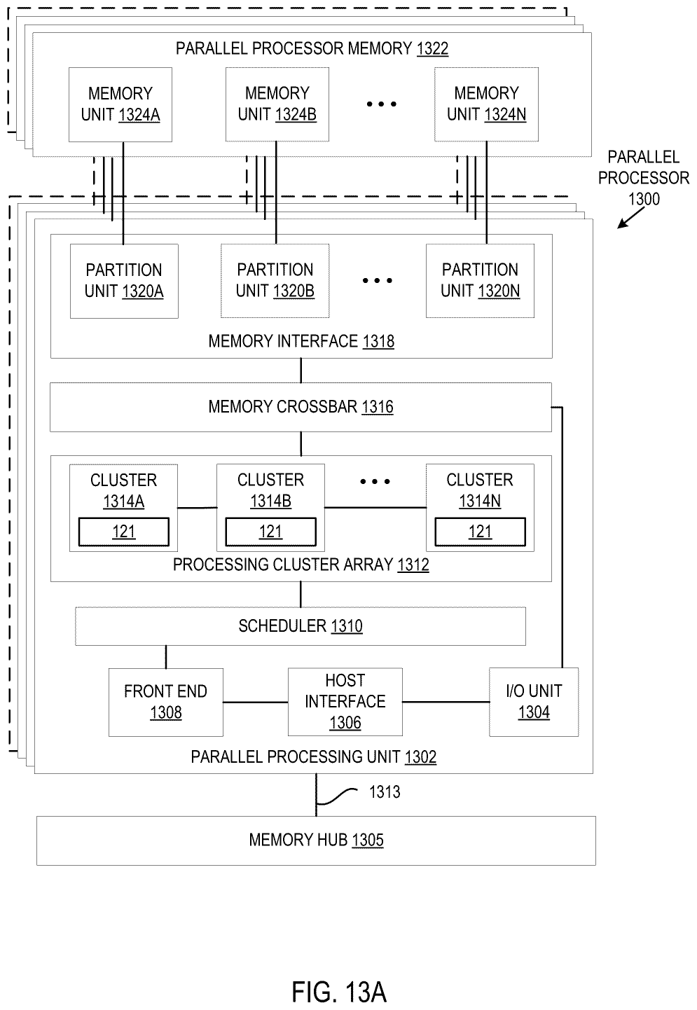

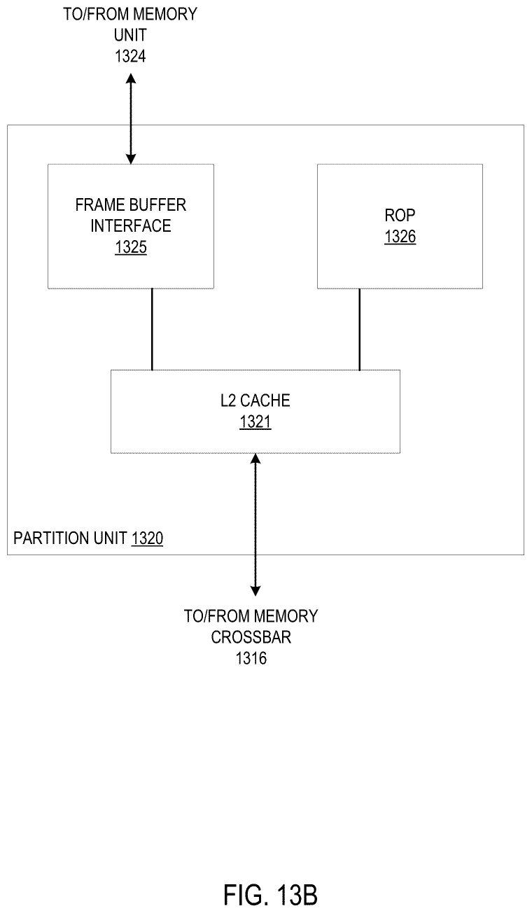

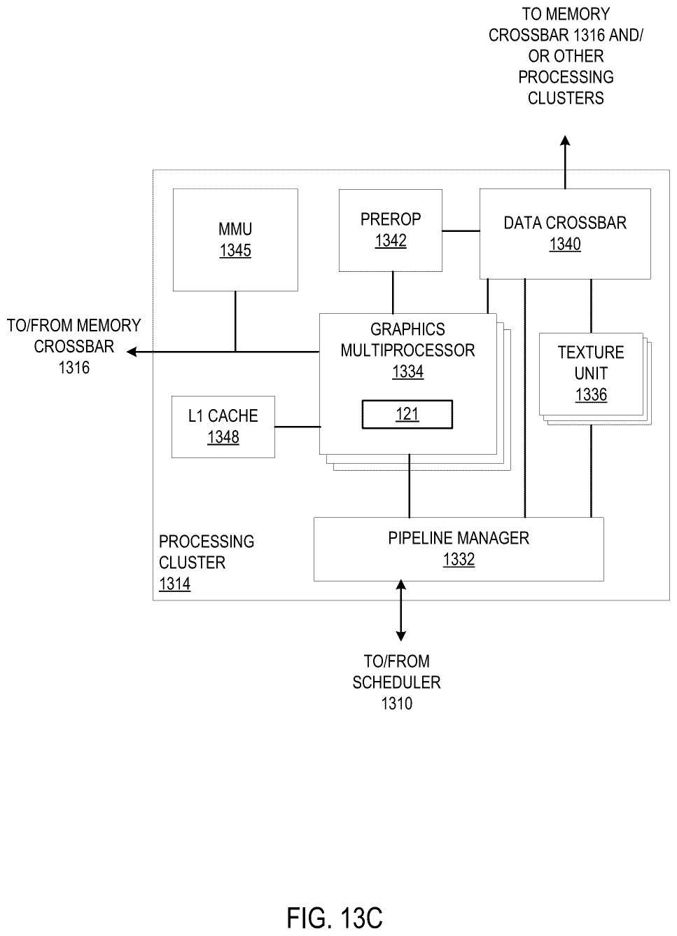

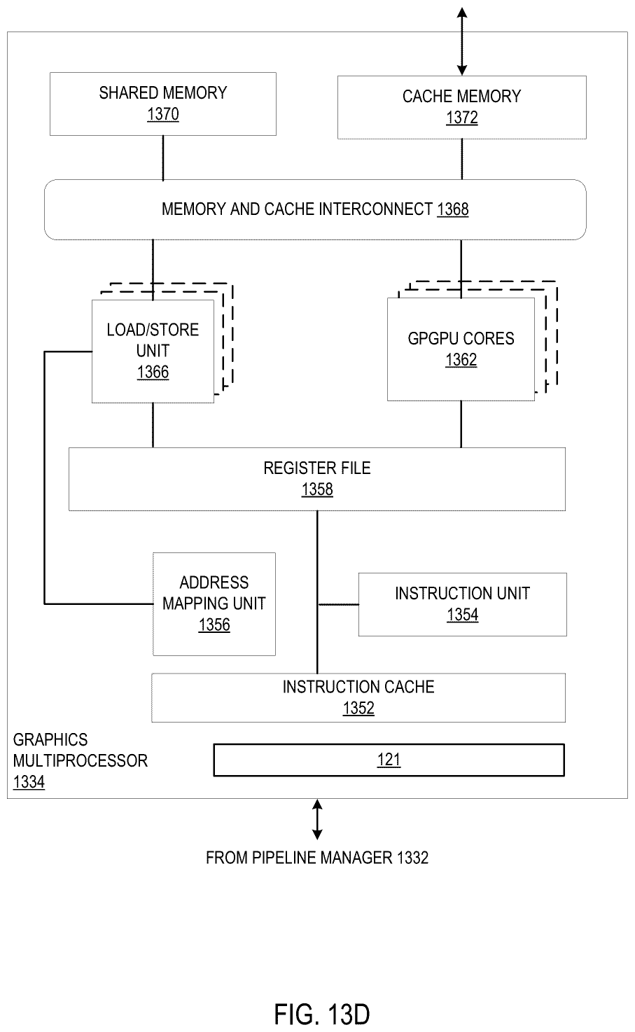

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of the one or more parallel processor(s) 1212 shown in FIG. 12.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1316, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct operations to perform those commands to a front end 1308. In at least one embodiment, front end 1308 couples with a scheduler 1310, which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, e.g., enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs, for example, such as vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM). In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13 (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, such as one of one or more display device(s) 810 of FIG. 8, routed for further processing by processor(s) 802, or routed for further processing by one of processing entities within parallel processor 1300 of FIG. 13A.

FIG. 13C is a block diagram of a processing cluster 1314 within a parallel processing unit according to at least one embodiment. In at least one embodiment, a processing cluster is an instance of one of processing clusters 1314A-1314N of FIG. 13A. In at least one embodiment, processing cluster 1314 can be configured to execute many threads in parallel, where “thread” refers to an instance of a particular program executing on a particular set of input data. In at least one embodiment, single-instruction, multiple-data (SIMD) instruction issue techniques are used to support parallel execution of a large number of threads without providing multiple independent instruction units. In at least one embodiment, single-instruction, multiple-thread (SIMT) techniques are used to support parallel execution of a large number of generally synchronized threads, using a common instruction unit configured to issue instructions to a set of processing engines within each one of processing clusters.

In at least one embodiment, operation of processing cluster 1314 can be controlled via a pipeline manager 1332 that distributes processing tasks to SIMT parallel processors. In at least one embodiment, pipeline manager 1332 receives instructions from scheduler 1310 of FIG. 13A and manages execution of those instructions via a graphics multiprocessor 1334 and/or a texture unit 1336. In at least one embodiment, graphics multiprocessor 1334 is an exemplary instance of a SIMT parallel processor. However, in at least one embodiment, various types of SIMT parallel processors of differing architectures may be included within processing cluster 1314. In at least one embodiment, one or more instances of graphics multiprocessor 1334 can be included within a processing cluster 1314. In at least one embodiment, graphics multiprocessor 1334 can process data and a data crossbar 1340 can be used to distribute processed data to one of multiple possible destinations, including other shader units. In at least one embodiment, pipeline manager 1332 can facilitate distribution of processed data by specifying destinations for processed data to be distributed via data crossbar 1340.

In at least one embodiment, each graphics multiprocessor 1334 within processing cluster 1314 can include an identical set of functional execution logic (e.g., arithmetic logic units, load-store units, etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 1314 constitute a thread. In at least one embodiment, a set of threads executing across a set of parallel processing engines is a thread group. In at least one embodiment, a thread group executes a common program on different input data. In at least one embodiment, each thread within a thread group can be assigned to a different processing engine within a graphics multiprocessor 1334. In at least one embodiment, a thread group may include fewer threads than a number of processing engines within graphics multiprocessor 1334. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 1334. In at least one embodiment, when a thread group includes more threads than number of processing engines within graphics multiprocessor 1334, processing can be performed over consecutive clock cycles. In at least one embodiment, multiple thread groups can be executed concurrently on a graphics multiprocessor 1334.

In at least one embodiment, graphics multiprocessor 1334 includes an internal cache memory to perform load and store operations. In at least one embodiment, graphics multiprocessor 1334 can forego an internal cache and use a cache memory (e.g., L1 cache 1348) within processing cluster 1314. In at least one embodiment, each graphics multiprocessor 1334 also has access to L2 caches within partition units (e.g., partition units 1320A-1320N of FIG. 13A) that are shared among all processing clusters 1314 and may be used to transfer data between threads. In at least one embodiment, graphics multiprocessor 1334 may also access off-chip global memory, which can include one or more of local parallel processor memory and/or system memory. In at least one embodiment, any memory external to parallel processing unit 1302 may be used as global memory. In at least one embodiment, processing cluster 1314 includes multiple instances of graphics multiprocessor 1334 and can share common instructions and data, which may be stored in L1 cache 1348.

In at least one embodiment, each processing cluster 1314 may include an MMU 1345 (memory management unit) that is configured to map virtual addresses into physical addresses. In at least one embodiment, one or more instances of MMU 1345 may reside within memory interface 1318 of FIG. 13A. In at least one embodiment, MMU 1345 includes a set of page table entries (PTEs) used to map a virtual address to a physical address of a tile and optionally a cache line index. In at least one embodiment, MMU 1345 may include address translation lookaside buffers (TLB) or caches that may reside within graphics multiprocessor 1334 or L1 1348 cache or processing cluster 1314. In at least one embodiment, a physical address is processed to distribute surface data access locally to allow for efficient request interleaving among partition units. In at least one embodiment, a cache line index may be used to determine whether a request for a cache line is a hit or miss.

In at least one embodiment, a processing cluster 1314 may be configured such that each graphics multiprocessor 1334 is coupled to a texture unit 1336 for performing texture mapping operations, e.g., determining texture sample positions, reading texture data, and filtering texture data. In at least one embodiment, texture data is read from an internal texture L1 cache (not shown) or from an L1 cache within graphics multiprocessor 1334 and is fetched from an L2 cache, local parallel processor memory, or system memory, as needed. In at least one embodiment, each graphics multiprocessor 1334 outputs processed tasks to data crossbar 1340 to provide processed task to another processing cluster 1314 for further processing or to store processed task in an L2 cache, local parallel processor memory, or system memory via memory crossbar 1316. In at least one embodiment, a preROP 1342 (pre-raster operations unit) is configured to receive data from graphics multiprocessor 1334, and direct data to ROP units, which may be located with partition units as described herein (e.g., partition units 1320A-1320N of FIG. 13A). In at least one embodiment, preROP 1342 unit can perform optimizations for color blending, organizing pixel color data, and performing address translations.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the processing cluster 1314 of FIG. 13C for performing image processing operations, including object detection and segmentation operations.

FIG. 13D shows a graphics multiprocessor 1334 according to at least one embodiment. In at least one embodiment, graphics multiprocessor 1334 couples with pipeline manager 1332 of processing cluster 1314. In at least one embodiment, graphics multiprocessor 1334 has an execution pipeline including but not limited to an instruction cache 1352, an instruction unit 1354, an address mapping unit 1356, a register 1358, one or more general purpose graphics processing unit (GPGPU) cores 1362, and one or more load/store units 1366. In at least one embodiment, GPGPU cores 1362 and load/store units 1366 are coupled with cache memory 1372 and shared memory 1370 via a memory and cache interconnect 1368.

In at least one embodiment, instruction cache 1352 receives a stream of instructions to execute from pipeline manager 1332. In at least one embodiment, instructions are cached in instruction cache 1352 and dispatched for execution by an instruction unit 1354. In at least one embodiment, instruction unit 1354 can dispatch instructions as thread groups (e.g., warps), with each thread of thread group assigned to a different execution unit within GPGPU cores 1362. In at least one embodiment, an instruction can access any of a local, shared, or global address space by specifying an address within a unified address space. In at least one embodiment, address mapping unit 1356 can be used to translate addresses in a unified address space into a distinct memory address that can be accessed by load/store units 1366.

In at least one embodiment, register 1358 provides a set of registers for functional units of graphics multiprocessor 1334. In at least one embodiment, register 1358 provides temporary storage for operands connected to data paths of functional units (e.g., GPGPU cores 1362, load/store units 1366) of graphics multiprocessor 1334. In at least one embodiment, register 1358 is divided between each of functional units such that each functional unit is allocated a dedicated portion of register 1358. In at least one embodiment, register 1358 is divided between different warps being executed by graphics multiprocessor 1334.

In at least one embodiment, GPGPU cores 1362 can each include floating point units (FPUs) and/or integer arithmetic logic units (ALUs) that are used to execute instructions of graphics multiprocessor 1334. In at least one embodiment, GPGPU cores 1362 can be similar in architecture or can differ in architecture. In at least one embodiment, a first portion of GPGPU cores 1362 include a single precision FPU and an integer ALU while a second portion of GPGPU cores include a double precision FPU. In at least one embodiment, FPUs can implement IEEE 754-2008 standard floating point arithmetic or enable variable precision floating point arithmetic. In at least one embodiment, graphics multiprocessor 1334 can additionally include one or more fixed function or special function units to perform specific functions such as copy rectangle or pixel blending operations. In at least one embodiment, one or more of GPGPU cores 1362 can also include fixed or special function logic.

In at least one embodiment, GPGPU cores 1362 include SIMD logic capable of performing a single instruction on multiple sets of data. In at least one embodiment, GPGPU cores 1362 can physically execute SIMD4, SIMD8, and SIMD16 instructions and logically execute SIMD1, SIMD2, and SIMD32 instructions. In at least one embodiment, SIMD instructions for GPGPU cores can be generated at compile time by a shader compiler or automatically generated when executing programs written and compiled for single program multiple data (SPMD) or SIMT architectures. In at least one embodiment, multiple threads of a program configured for an SIMT execution model can executed via a single SIMD instruction. For example, in at least one embodiment, eight SIMT threads that perform same or similar operations can be executed in parallel via a single SIMD8 logic unit.

In at least one embodiment, memory and cache interconnect 1368 is an interconnect network that connects each functional unit of graphics multiprocessor 1334 to register 1358 and to shared memory 1370. In at least one embodiment, memory and cache interconnect 1368 is a crossbar interconnect that allows load/store unit 1366 to implement load and store operations between shared memory 1370 and register 1358. In at least one embodiment, register 1358 can operate at a same frequency as GPGPU cores 1362, thus data transfer between GPGPU cores 1362 and register 1358 can have very low latency. In at least one embodiment, shared memory 1370 can be used to enable communication between threads that execute on functional units within graphics multiprocessor 1334. In at least one embodiment, cache memory 1372 can be used as a data cache for example, to cache texture data communicated between functional units and texture unit 1336. In at least one embodiment, shared memory 1370 can also be used as a program managed cache. In at least one embodiment, threads executing on GPGPU cores 1362 can programmatically store data within shared memory in addition to automatically cached data that is stored within cache memory 1372.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink). In at least one embodiment, a GPU may be integrated on a package or chip as cores and communicatively coupled to cores over an internal processor bus/interconnect internal to a package or chip. In at least one embodiment, regardless a manner in which a GPU is connected, processor cores may allocate work to such GPU in a form of sequences of commands/instructions contained in a work descriptor. In at least one embodiment, that GPU then uses dedicated circuitry/logic for efficiently processing these commands/instructions.

Image processing logic 121 may be used to perform image processing operations, including object detection and segmentation operations, associated with one or more embodiments. Details regarding image processing logic 121 are provided herein in conjunction with FIG. 1. In at least one embodiment, image processing logic 121 may be used in the graphics multiprocessor 1334 of FIG. 13D for performing image processing operations, including object detection and segmentation operations.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
one or more processors to execute a processing pipeline to detect an object based at least on iteratively transforming and processing input data that includes at least one representation of the object, and aggregating results of each iteration to generate a combined object detection result.

2. The system of claim 1, wherein for at least one iteration, the one or more processors are further to:
apply a data transformation to the input data according to one or more values of one or more data transformation parameters to generate transformed data; and
perform object detection on the transformed data according to one or more values of one or more object detection parameters to generate an object mask.

3. The system of claim 1, wherein the one or more processors comprise parallel processing circuitry to accelerate application of the data transformation and performance of the object detection.

4. The system of claim 1, wherein the one or more processors are to perform the iteratively transforming and processing until a determination that a termination criteria has been satisfied, and wherein the aggregating of the results comprises merging object masks associated with two or more iterations to obtain a combined object mask.

5. The system of claim 2, wherein the one or more processors are further to:
responsive to a determination that a termination criteria has not been satisfied, update at least one value of at least one of the one or more data transformation parameters and at least one value of at least one of the one or more object detection parameters;
apply a data transformation to the input data according to the at least one updated value of the at least one of the one or more data transformation parameters to generate new transformed data; and
perform the object detection on the new transformed data according to the at least one updated value of the at least one of the one or more object detection parameters to obtain a new object mask.

6. The system of claim 4, wherein the one or more processors are further to:
determine an incremental detection amount based at least on a comparison of the object mask with one or more existing object masks; and
determine that the termination criteria has been satisfied based at least on the incremental detection amount.

7. The system of claim 4, wherein the one or more processors are further to:
determine an incremental object mask as the difference between the object mask and one or more existing object masks.

8. The system of claim 1, wherein the iteratively transforming comprises applying a spatial filter to the input data.

9. The system of claim 1, wherein the one or more processors are further to:
select a data transformation type corresponding to the iteratively transforming based at least on an object type corresponding to the object.

10. The system of claim 1, wherein the input data corresponds to a plurality of voxels and a result of the object detection is an object mask identifying at least a subset of the plurality of voxels corresponding to the object.

11. The system of claim 1, wherein the one or more processors comprise one or more parallel processing units, and wherein the one or more parallel processing units apply the data transformation to the input data for multiple iterations in parallel.

12. The system of claim 12, wherein the one or more parallel processing units are further to:
perform the object detection on the transformed data for multiple iterations in parallel.

13. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for presenting one or more of virtual reality content, augmented reality content, or mixed reality content;
a system for hosting one or more real-time streaming applications;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

14. A method comprising:
executing a processing pipeline to detect an object represented using input data, the processing pipeline including a plurality of operations including:
iteratively transforming and processing the input data;
aggregating results of the iteratively transforming and processing; and
processing the aggregated results to generate a combined object detection result.

15. The method of claim 14, wherein at least one iteration of the iteratively transforming and processing includes:
applying a data transformation to the input data according to one or more values of one or more data transformation parameters to generate transformed data; and
performing an object detection on the transformed data according to one or more values of one or more object detection parameters to generate an object mask.

16. The method of claim 15, wherein the iteratively transforming and processing is performed until a determination that a termination criteria has been satisfied, and wherein the aggregating the results comprises merging object masks associated with each iteration to obtain a combined object mask.

17. A processor comprising one or more processing units to:
determine a combined object detection result corresponding to input data based at least on performing a plurality of processing iterations with respect to the input data, wherein at least two processing iterations of the plurality of processing iterations include different transformations of the input data.

18. The processor of claim 17, wherein at least one processing iteration of the plurality of processing iterations includes:
applying a data transformation to the input data according to one or values of one or more data transformation parameters to generate transformed data; and
performing an object detection on the transformed data according to one or more values of one or more object detection parameters to generate an object mask.

19. The processor of claim 17, wherein a number of processing iterations of the plurality of processing iterations is determined based at least on a termination criteria.

20. The processor of claim 17, wherein the processor comprises parallel processing circuitry to accelerate performing the plurality of processing iterations with respect to the input data.
